(19) United States
(12) Patent Application Publication
(10) Pub. No.: US 2008/0037880 A1
(43) Pub. Date: Feb. 14, 2008

(54) Scalable, progressive image compression and archiving system over a low bit rate internet protocol network

(75) Inventor: John H. S. Lai, Milford, NH (US)

Correspondence Address: EDWARDS ANGELL PALMER & DODGE LLP, P.O. BOX 55874, BOSTON, MA, 02205, US

(73) Assignee: LCJ Enterprises LLC

(21) Appl. No.: 11/502,975

(22) Filed: Aug. 11, 2006

(51) Int. Cl. G06K 9/36; H04B 1/66; G06K 9/46

(52) U.S. Cl. 382/232; 375/240

(57) ABSTRACT

An on-demand, interactive, scalable, image data compressor, data archiving, transmission and presentation system comprising a server, a compression engine, memory and user interface capable of communicating with the server is described. The compression engine provides progressive transmission of a compressed image and provides both a tree based compression method and a context based, code block encoding compression method, either of which are selectable by the user on demand. The compression engine can switch automatically from a lossy compression to a lossless compression to achieve a desired quality of decompressed images.

### FIELD OF THE INVENTION

This invention is in the field of data compression for the use in image data archiving and transmission, particularly, an intelligent scalable image data compression, storage and display system over a distributed low bit rate IP network.

### BACKGROUND OF THE INVENTION

Image data compression, storage and display systems are known. A three-tiered, client-server architecture has been described (Sadoski 00).

A client refers to an end user application that handles user interface. Based on instructional command messages of the users, this presentation layer allows the user to view data, to navigate data, to send information requested, to acknowledge response from the server, to present results on the screen for viewing purpose, and the like.

A server listens to client's query, authenticates the client, processes queries and returns requested results to the client or returns error messages if erroneous procedures are encountered.

A distributed client server architect allows client applications or programs to communicate with the server from different physical locations. This architecture eliminates the need for redundant business functions in different presentation layers.

An operating system has a finite pool of resources and memory. A thread is a stream of executable code that has its independent state and priority. It shares memory space with the system process (Cohen 98). An efficient client server program can be structured as a multithreaded process with each independent worker thread running its executable tasks asynchronously in the background.

In most images, neighboring pixels are correlated and therefore contain redundant information. The objective of image compression is to find less correlated representation of the image. Modern compression engines consist of three main components (Gonzalez 92):
1. Transform Encoder
2. Quantizer
3. Tree based encoder or Codeblock based encoder

### A general compression scheme is illustrated in FIGS. 1a-1b, where FIG. 1a illustrates the compression steps and FIG. 1b illustrates the decompression steps.

The transform used for encoding can be orthogonal, bi-orthogonal or non-orthogonal. The outcome of transform base encoder on an image is a set of highly decorrelated coefficients. Transforms comes in a pair, i.e., a forward transform and an inverse transform, depending on whether it is used to encode (compress—forward transform) or to decode (uncompress—inverse transform) an image.

The majority of modern compression engines are based upon the Discrete Cosine Transform (DCT). Other transform methods exist, one of which is known as the Discrete Wavelet Transform (generally referred to as “WT” hereafter). The use of WT is discussed in more detail hereinafter.

The transform operation does not compress an image. Its role is to make an image's energy as compact as possible. It produces a data format which can then be compressed by the subsequent encoding operation, generally performed by a tree based or codeblock based encoder.

DCT is an orthogonal transform and it transforms a signal or image from spatial (time) domain to the frequency domain. WT can be orthogonal, non-orthogonal or bi-orthogonal. It transforms a signal from spatial domain to a joint spatial-scale domain. WT compacts energy of input into relatively small number of wavelet coefficients. One dimensional WT consists of a Low (L) and a High (H) pass filter decimating the input signal in half. Application of the filters to a two dimensional image in horizontal and vertical directions produces four subbands labeled by LL, LH, HL and HH. Together, these four quadrants constitute a resolution plane. Further decompositions can take place in LL quadrant.

Images generated by certain industry sectors such as satellite remote sensing, health care, arts and entertainment are intrinsically large in nature. Compression of such images or sequence of images with lossless or high quality lossy compression schemes will reduce the demand for substantial large image data storage infrastructures, and facilitate the transmission of these image data over the bandwidth limited IP network.

A choice of compression schemes also is desirable to accommodate different types of data and different objectives. Thus, new and better systems for compressing and archiving image data are desired. It is particularly desirable to achieve a high quality data image system capable of delivering large volumes of data images over a distributed, low bit rate IP network.

### SUMMARY OF THE INVENTION

The present invention provides an on-demand, interactive, scalable, image data compressor, data archiving, transmission and presentation system wherein the compression scheme supports progressive transmission of a compressed image and provides both a tree based compression method and a context based, code block encoding compression method, either of which the user can select on demand. The system, which is capable of accommodating a large volume of images or image related data for retrieval over a low bandwidth (i.e., low bit rate) network, comprises a server, a compression engine, efficient memory management and one or more user interfaces capable of communicating with the server. Due to the system availability of both a tree based compression method and a context based, code block encoding compression method, preferred embodiments of the system can switch automatically from either compression regimes and from a lossy compression to a lossless compression in order to achieve desired quality of compressed images.

Preferably, the system of the present invention is an intelligent interactive, scalable and multi-resolution image archiving system for a large volume of images or image related data and retrieving the data over a low bandwidth (i.e. low bit rate) Internet Protocol (IP) network. In certain embodiments of the invention, an image archiving server compresses individual images or a sequence of related images (i.e. cine loop or motion picture) residing in server's memory database for permanent storage or for on-demand transmission of an image file(s) or image related data file(s) over an IP network. The image compression engine preferably is a software and/or dedicated hardware based, on-demand, image compression engine that allows the user to specify the amount of compression to perform. In some preferred embodiments, an adaptive compression engine learns, and advises users of, an ideal compression ratio based on objective and subjective compressed image quality measurements, the type of image content and the best choice of available compression engines that can achieve the users' desired demands. Alternative embodiments of the invention include an on-demand, selective image compression engine that can compress a specified region of interest (ROI) of an image or a specified volume of interest (VOI) for a sequence of related images. Within the context of this document, compression ratio is defined as the ratio between the file size of original image and the file size of the compressed image.

In other preferred embodiments, the server provides a scalable image that enables a client to preview a lower resolution of the original image or sequence of images before transmission or to view the image at a lower resolution before transmission is completed. Preferably, a progressive image display system is utilized wherein an image will be transmitted to the end user scalable from the lowest resolution level to the full resolution level pending the bandwidth availability.

Preferred embodiments of the invention comprise a progressive compression and transmission regime that supports compression utilizing both the Spatial Partitioning in Hierarchical Trees (SPIHT) and the Embedded Block Coding with Optimal Truncation (EBCOT) architectures.

A preferred paradigm utilizing the present invention spans a three tiered client/server architecture over an internet protocol (“IP”) network. Thus, a source of image data generation can be connected to the centralized image storage database through an IP network.

Features of some preferred embodiments of the invention include a compression ratio lookup table (LUT) in conjunction with the various available compression engines, which can recommend an optimal compression ratio to a user. The table classifies image types, e.g., based on the source of origin of the image or the methods of generation of the images, and can include precompiled statistical records of compression ratio for the various types of images currently stored. Thus, the lookup table preferably provides a set of templates of recommended compression ratios that statistically provides a recommended best compression ratio (i.e. the optimal compression ratio mentioned) with regard to the resultant compressed image quality for the corresponding classes of images if the image data are chosen to be compressed in lossy mode. This look up table is not used for a lossless compression mode.

Embodiments of the invention also can include a cine loop (or motion picture) generation engine. A cine loop generating engine is defined by the capability of the generation of a sequence of (usually related) images to convey the effect of motion or impression of a certain chronological order. For purposes of the present invention, the terms cine loop, motion picture and video can be used interchangeably and in all instances, refer to the images produced by a cine loop generation engine.

If the client requests the generation of a video clip of a specified sequence of uncompressed/compressed images, upon the return of the sequence of uncompressed/compressed images from the compressor, the server will invoke the video generation engine to create the requested item. Frame rate information must be provided by the user from the client side, otherwise a default frame rate, typically, 30 frames per second will be used. In certain preferred embodiments of the invention, the image video can be moved incrementally forward or backward as well.

Embodiments of the present invention also provide a method for providing image data to an end user over a low bit rate internet protocol network, the method comprising: providing an on-demand, interactive, scalable, image data compressor, data archiving, transmission and presentation system, as described herein; storing image data in the system; selecting a set of image data to be transmitted to an end user; identifying a minimum level of image quality to be viewed by the end user for the set of image data selected; compressing the selected set of image data by one of a tree based compression method and a context based, code block encoding compression method on demand; transmitting the compressed image data to the end user; and decompressing the compressed image data to provide an image having at least the minimum level of image quality for viewing by the end user.

Certain embodiments also provide a method for providing image data to an end user over a low bit rate internet protocol network, the method comprising: providing an on-demand, interactive, scalable, image data compressor, data archiving, transmission and presentation system, as described herein; storing image data in the system; selecting a set of image data to be transmitted to an end user; identifying a compression ratio to provide a minimum level of image quality to be viewed by the end user for the set of image data selected; compressing the selected set of image data by one of a tree based compression method and a context based, code block encoding compression method on demand; transmitting the compressed image data to the end user; and decompressing the compressed image data to provide an image having at least the minimum level of image quality for viewing by the end user.

Further provided is a method for archiving image data for transmission to an end user over a low bit rate internet protocol network, the method comprising: providing an on-demand, interactive, scalable, image data compressor, data archiving, transmission and presentation system, as described herein; selecting a set of image data to be archived for subsequent viewing by an end user; identifying a minimum level of image quality for the reconstructed image for the set of image data selected; compressing the selected set of image data by one of a tree based compression method and a context based, code block encoding compression method on demand; and storing the compressed image data.

Other embodiments provide a method for archiving image data for transmission to an end user over a low bit rate internet protocol network, the method comprising: providing an on-demand, interactive, scalable, image data compressor, data archiving, transmission and presentation system, as described herein; selecting a set of image data to be archived for subsequent viewing by an end user; identifying a compression ratio to provide a minimum level of image quality to be viewed by the end user for the set of image data selected; compressing the selected set of image data by one of a tree based compression method and a context based, code block encoding compression method on demand; and storing the compressed image data.

### BRIEF DESCRIPTION OF THE DRAWINGS

FIG. 1a is a schematic illustration of image compression architecture.

FIG. 1b is a schematic illustration of image decompression architecture.

FIG. 2 is a schematic illustration of a three tier client server architecture.

FIG. 3 is a schematic illustration of a three tiered, client server enterprise, image storage and communication network environment in accord with the present invention.

FIG. 4a is an illustration of an original image.

FIG. 4b is an illustration of an one level wavelet decomposition layout for the image of FIG. 4a.

FIG. 4c is as an illustration of an one level wavelet decomposition of the image of FIG. 4a.

FIG. 5 is a schematic illustration of a tree data structure.

FIG. 6a is an illustration of a tree structure decomposition layout utilizing EZW to compress an image in accord with the present invention.

FIG. 6b is an illustration of a tree structure decomposition layout utilizing SPIHT to compress an image in accord with the present invention.

FIG. 7 is a flowchart illustrating SPIHT encoding of an image in accord with the present invention.

FIG. 8 is a schematic illustration of bit plane encoding.

FIG. 9 is a flowchart illustrating Tier 1 coding utilizing EBCOT to compress an image in accord with the present invention.

FIG. 10a is an illustration of an image tile.

FIG. 10b is an illustration of subband decomposition wherein the tile of FIG. 10a is subdivided into four precincts.

FIG. 10c is an illustration of codeblock subdivision of a precinct of FIG. 10b.

FIG. 10d is an illustration of packetization of a codeblock of FIG. 10c.

FIG. 11 is a graph illustrating scaling of ROI coefficients utilized in certain embodiments of the present invention.

FIG. 12 is a flowchart illustrating operation of a distributed client-server ROI architecture in accord with the present invention.

FIG. 13a is an illustration of tiling of an image in accord with the present invention.

FIG. 13b is an illustration of using WT transform on the tiles of FIG. 13a in accord with the present invention.

FIG. 13c is an illustration of using three levels of WT subband decomposition of a tile FIG. 13a.

FIG. 14 is a flowchart illustrating a switchable compression architecture in accord with the present invention.

FIG. 15 is a block diagram illustrating a one level wavelet transform.

FIG. 16 is a three levels decomposition of a one dimensional (1D) forward WT.

FIG. 17 is a three levels recomposition of a one dimensional (1D) inversed (i.e., reversed) WT.

FIG. 18 is a three levels decomposition of a two dimensional (2D) forward WT.

FIG. 19 is a block diagram for forward Lifting Scheme FIG. 20 illustrates the relationship between wavelet and scaling coefficients for Lifting Scheme.

FIG. 21 is a block diagram for inverse (i.e. reverse) Lifting Scheme

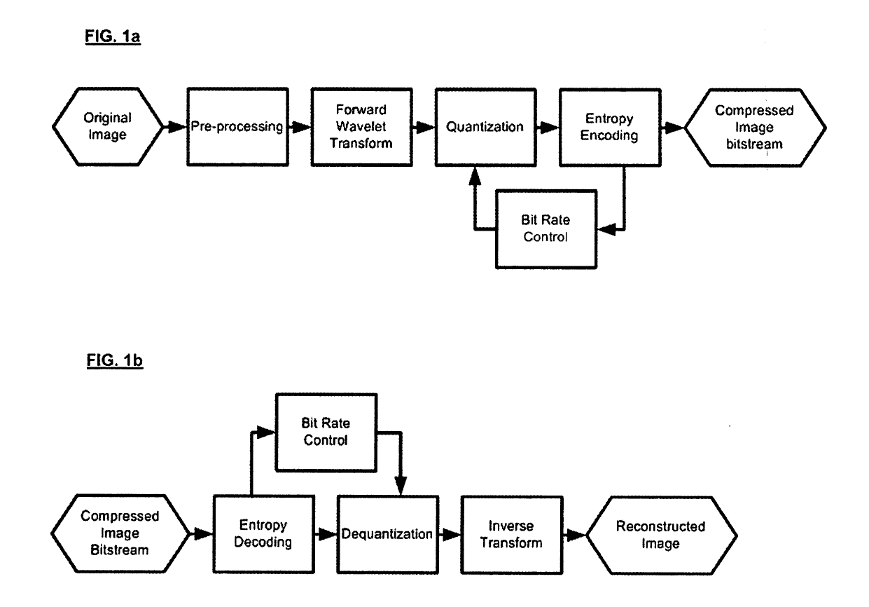

### DETAILED DESCRIPTION OF THE PREFERRED EMBODIMENTS

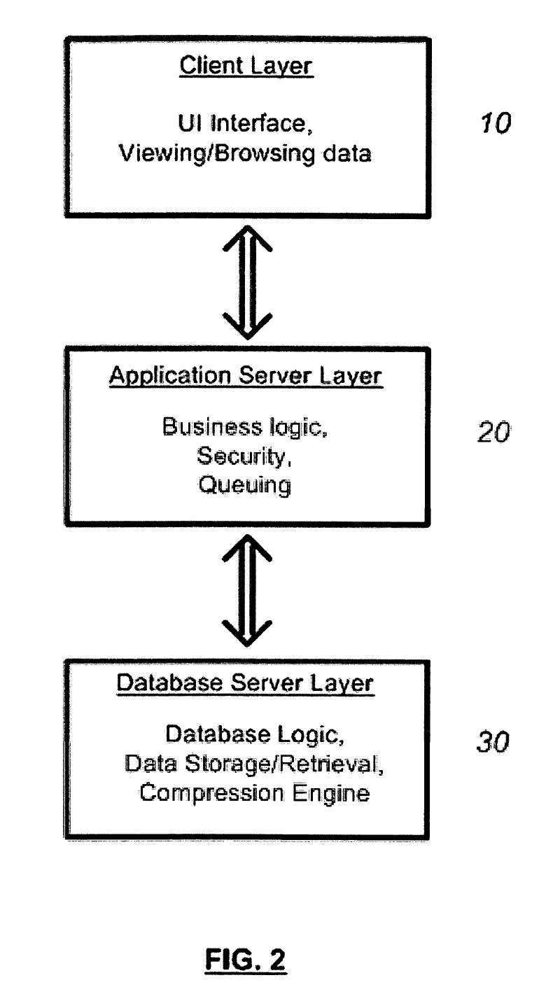

As illustrated in the drawings, the present invention provides an on-demand, highly scalable and distributive image data compression archiving architecture for file transfer over a limited bandwidth environment which is based on a three-tiered, client-server, and networked computing architecture embodiment of the invention. The three-tiered architecture, as illustrated in FIG. 2, comprises a client layer 10, a application server middle tier layer 20 and a database server layer 30. The distinctive components of the three-tiered architecture can be described as follows:
a. Client Tier 10: this is the presentation layer where the application runs on terminals operated by the users.
b. Application Server Tier 20: this is the application layer where most of the business logical computation is done and where security access/denial is performed.
c. Database Server Tier 30: this is the database layer where the application manages persistent data storage.

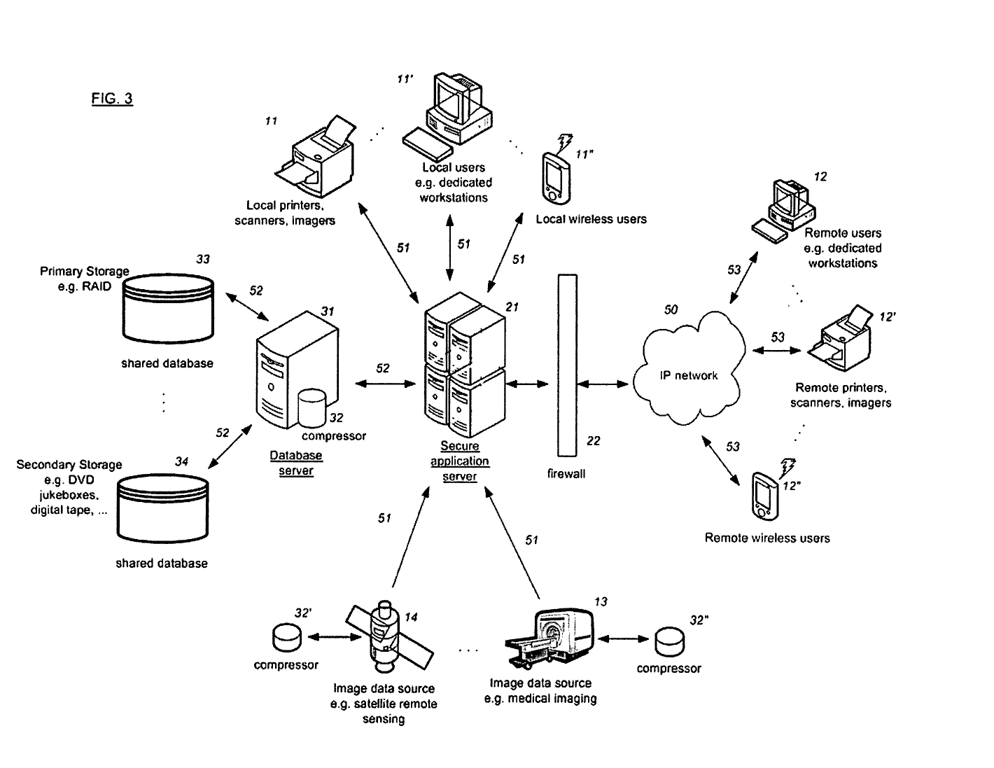

The client layer or presentation layer 10 is the client interface (“client”), which serves primarily as a browser medium and can receive data inputs from the user and display graphical outputs to the user. The client can be connected to the secure application server as a local user group via intranet or as a remote user group via an IP network (FIG. 3). The client can be a dedicated workstation or a portable wireless instrument with input devices such as keyboard, pointing device, touch screen, etc. and output device such as a video screen. A built-in image data cache system is required to buffer the image data of the viewing section for display.

The process management middle tier layer 20 comprises the application server. It can serve multiple concurrent clients (both the presentation layer and the data storage layer) using connection transport protocol TCP/IP (Comer 97). The IP enables one device to set up a connection to a remote device using a unique address, i.e. IP address. The Transmission Control Protocol, TCP, provides the connection between the devices. The middle tier layer may span over a network of workstations depending on the demand on system resources; hence, the size of the server system is scalable. It preferably is configured to execute IP security protocol and is protected from the IP side with a firewall.

The database management layer 30 includes a Database Server 31 and, preferably, manifests itself as a standalone storage system or as an IP Storage Area Network (IP-SAN). This storage system is augmented with a high speed sub-network of primary storage systems such as RAID (Redundant Array of Independent Disk) 33 and/or secondary storage systems such as optical disk array storage systems 34, as illustrated in FIG. 3. The Database Server connects to the Application Server via gigabit backbone network or Asynchronous Transfer Mode (ATM) network for data communications 52.

The database server generally will receive two sources of input requests. One source is the consumer, i.e. the user on the client side (local or remote), which requests certain files or folders. The other source is the producer, the original image data generation source. Both the user (i.e., image receiver) and the producer of the images can be considered “end users” on the client level for purposes of the present invention. The database server responds differently to the requests from the end users (or clients). All clients' requests are fed into the Database Server tier 30 from the Application Server tier 20 (the “middle tier”) via gigabit Ethernet and/or ATM.

FIG. 3 illustrates a type of image data system within the scope of the present invention. In this embodiment, a secure application server 21 provides the middle tier application server layer and is linked to a database server 31, which provides the database management layer. The compression engine 32, 32′, 32″ (i.e., compressor) is shown as a separate component for illustration purposes, but may be included within the database server and/or at image generation (or gathering) source. Having the compression engine located near the data source can be particularly advantageous for archiving compressed images when a standard compression ratio for the type of image data has been established or a compression ratio has been selected by the user for particular data.

The database server can include various types of data storage devices as an integral component or as separate components 33, 34. Examples of suitable data storage devices include RAID disk arrays, optical storage drives, digital (and/or analog) magnetic tape drives and the like. The client layer can include local users 11′, local wireless users 11″, local printers/imagers/scanners 11, image data sources 13, 14, and other remote users 12, remote wireless users 12″, remote printers/imagers/scanners 12′ connected by an IP network and/or wireless IP network 50 and/or a Local Area Network, LAN and/or Wireless Local Area Network, WLAN, 51. The network can be a private network or an

IP network. Preferably, a firewall is used for security in the case of non-local users. Image data sources also can be non-local, although that is not preferred unless connected through high speed data lines. Access of information between the end users (i.e. the clients) and the server is through a transport security layer, 51, 52, 53, such as Secure Sockets Layer or Transport Layer Security. These protocols provide transaction request authentication and data privacy over the IP network using cryptography such as public key cryptography.

As far as the system architecture is concerned, the application server layer and the data storage layer is invisible (i.e., encapsulated) to the end user. Collectively, the end user addresses this abstraction as the server. The database server continuously monitors messages from both the image data generation sources and end users through the application server, which queues and coordinates communications between the database server and the client layer.

A potential end user (client) preferably will have a predetermined encrypted key(s) for the initiation of a secure communications. The key may be, for example, a combination of a user ID and a password. Once logged in on the client side, the end user can request the image files/folders that he/she has the privilege to access. This process is determined and authenticated by the middle tier. Once access privilege is approved, the end user provides the identities of the image files or folders for which access is desired. These identities can be a combination of the name of the files/folders, serial number of the files/folders, classification of the images files (e.g., ultrasound images, etc. in medical field; or VIS (visible) images from channel 1 of NOAA, etc. in satellite imaging field; etc.). This identification can be used in image quality assurance calculations.

To ensure the best available compressed image quality, preferably, a statistical model based on past compression image quality is used. For example, this statistical model can classify image quality based on four criteria:
a. the subject origin of the image
b. the type of image generation device
c. the past history of the objective image quality measurement parameters, such as PSNR, MSE, etc. for the particular types of images based on criteria a and b.
d. the past history of subjective image quality measurement parameter, MOS, provided by the user for the particular types of images based on criteria a and b.

These four criteria may be subgrouped into 2 categories:
Group A: criteria a and b
Group B: criteria c and d

For example, images belonging to the same Group A are archived into the same folder. Therefore, all images in the same folder have common subject nature and are generated by the same type of imaging equipment. The statistical mean and standard deviation of the compression ratios corresponding to a given accepted image quality acceptance rate are calculated for the entire population (i.e. current total number of images in the folder). A confidence interval can be evaluated for a given confidence level, CF, such as 68 percentile, 95 percentile, etc.

If the total number of images within a folder is N, the Statistical mean, μ, is defined as

$$μ = \frac{{\sum }_{i = 0}^{N - 1} {X}_{i}}{N}$$

### Where Xᵢ represents the actual compression ratio used for the given image in this ensemble.

Variance, σ², is a measure of how spread out (from the mean, μ) are the compression ratios used for the images in a given folder. Variance can be defined as

$${σ}^{2} = \frac{{\sum }_{i = 0}^{N - 1} {( {X}_{i} - μ )}^{2}}{N}$$

and standard deviation σ is defined as the square root of the variance.

When requested, the standard deviation on the best compression ratio based on historical data archived for the particular type of imagery is presented to the user for guidance in selecting the compression ratio for current use. The confidence level from the database is presented to the user for guidance to make the decision. The above items help to provide a Quality of Service, QoS, for the compression engine.

If the requested image compression is one of a sequence of related images within a folder or that spans across a number of folders, preferably, the compression engine is programmed to link these images together. Then the compression engine compresses these images using the same set of parameters dictated by the end user for the base image.

Once the location(s) of the image data is (are) identified, the server returns the information to the screen display on the end user side. The content of these files or folders on the database server can be previewed by the user in form of thumbnails or in plain alphabetical file names and, if desired, along with the meta data corresponding to each image. The end user can visually identify the authenticity of the display thumbnails and the corresponding meta data to confirm the validity of the requested image file(s).

Once approved with the thumbnail(s), the user can highlight the region of interest, ROI, of the image he/she wants to retrieve with an input apparatus such as, e.g., a pointing device. If image(s) in the same folder are related, for example, if the images are time sequences of a particular object or the images are slices of a series of composite 3D medical images, the ROI specified for one image in the folder can automatically propagate to the corresponding regions for the rest of the images in the folder. If no ROI is specified, the system will default the ROI to be the area of the entire image.

A list of available compression formats such as “jpeg”, “jbig”, “jpc”, “jp2”, etc. preferably can be provided for the user to choose. If no format is dictated by the end user, a default output format is used, e.g., lossless “jp2”. Once the compression format is chosen, the end user is provided with a list of compression quality controlling parameters (the compression action list) described below. The parameters in this compression action list control the final outcome of the compression image quality. This action list includes the compression ratio (or alternatively the bit rate) and the desired tolerable limit for compressed image quality degradation (the error metrics) described below.

If there is more than one image involved, the same compression action list preferably is applied to all images located in the same folder (assuming all images in the same folder are related). The user can over-ride this default setting. In particular, if no compression ratio is stated by the user, preferably, the system defaults the compression engine to use a wavelet based, lossless compression architecture. Consequently, no compression information is needed. Alternatively, the system provides the user, a list of optimal compression parameters for the type of compression scheme chosen, in order to safeguard the best compressed image quality for the type of image in use.

The quality of the final compressed image can be examined by the traditional subjective visual inspection by imaging experts. Alternatively, this invention preferably provides a set of objective compressed image error measuring metrics to serve as an alternative, systematic and consistent objective diagnostic feedback for experts and casual users. These metrics can include, for example, Peak-Signal-To-Noise Ratio (PSNR), Mean Square Error (MSE), Root Mean Square Error (RMS), Mean Absolute Error (MAE), Quantitative Pixel Difference (PD), and the like. If no compression error measurement metric is chosen, system default to PSNR methodology.

If the image data involves a series of related images (e.g., within the same folder or a series of related folders), preferably, the user also can request the system to return a video clip of these images. For this scenario, the user has to specify what type of motion picture format he/she would like to receive, for example, mjpeg, mj2k, mj2, avi, etc. The user can choose to have a specific frame rate per second. If no parameter is filled in for this field, a default value of 30 frames per second will be chosen. The limit of displaying the chosen frame rate depends solely on the hardware of the current client console. Frame rate information is needed before the sequence of images is encoded. If this parameter is not filled by the end user, default setting is used. The end user forwards the above query information to the server and waits for response. Once the image data (and video data if applicable) is/are returned, the user can view the image(s) or video in applicable display players. Once image(s)/video data are received on the client side, the client can choose to save the image(s)/video on the local storage device(s).

The presentation layer of the client typically manifests itself as either a web user interface or as a propriety display interface application. Its existence is for user interface actions such as requesting image data with user tailored specifications, displaying image(s) or video, storing retrieved image or video data on a local drive etc. It has embedded digital image processing functionalities for post processing purposes. To accommodate large image file throughput, there is a memory data cache built in. This layer is collectively known as a Graphic User Interface, GUI. In this embodiment, this layer does not perform any image compression or transcoding processes. Transcoding is a process where one image format is translated into another.

From the interface, the GUI identifies the licensed server it is going to contact either by name or by IP address or through a browsable menu. Through the GUI, end user keys in the name and relevant IDs of the desired image data. The end user waits for the response from the server. If request is approved by the server, the end user can browse into the requested image folder residing in the centralized data base storage tier. Thumbnails of the contents of the folder requested by the user will be shown. The end user can choose the individual thumbnail to view. When chosen, the thumbnail will expand into full image. This viewing action does not take up storage resource either on the client side or at the database storage side.

The end user can choose from the GUI the resultant compression image file format types. The choice of image format dictates the compression algorithm being used. For example, choice of jpeg would imply Discrete Cosine Transform (DCT) engine will be deployed. Also, for example, choosing a jpc or jp2 format will imply that a Discrete Wavelet Transform (WT) engine will be used. The default image compression scheme is wavelet based. User also has a choice of compressing already compressed image files, such as transcoding from “jpeg” to “jpc” or vice versa.

The wavelet transform WT is explained as follows. The wavelet based transform operation does not compress an image. Its role is to make an image's energy as compact as possible. It produces a data format which can then be compressed by the subsequent encoding operation, generally performed herein by a tree based or codeblock based encoder.

Implementation of WT can be realized by digital filtering. Analysis of digital filter is done in z-domain. A z-transform is a mechanism that converts a discrete time domain signal, which is a sequence of real numbers or integers, into a complex frequency domain representation. The most common basic building block of WT is a Finite Impulse Response (FIR) based filter bank. This realization enables the desirable quality of linear phase (Grangetto 02).

A generic digital filter can be described as follows. If y(n) represents the desired discrete output signal by filtering the discrete input signal x(n) with an appropriate discrete FIR filter h(m), then the relationship between x(n) and y(n) can be described by the following:

$$y ( n ) = {\sum }_{m = p}^{m = q} h ( m ) x ( n - m )$$

where h(m) is the impulse response of the FIR filter and m, n, p, qεI (integer set) The z-transform of the FIR filter, (i.e. h (m)), is defined (Strum 89) as:

$$H ( z ) = {\sum }_{m = p}^{q} h ( m ) {z}^{- m}$$

where H(z) is a Laurent polynomial with degree |H|=q−p.
and z is a complex variable with z=e^{jω} where ω=angular frequency (in radian per sample). From hereon in, H(z), is referred to as filter.

A filter bank consists of an analysis part, for signal decomposition, and a synthesis part, for signal reconstruction (FIG. 15). An analysis filter is composed of a highpass filter, \tilde{G}, and a lowpass filter, \tilde{H}. Similarly, a synthesis filter is composed of a highpass filter, G, and a lowpass filter, H. The filter pairs, (H, G), (\tilde{H}, \tilde{G}) are called wavelet filters if they fulfill certain conditions (Vetterli 95). Realization of a one level (or a single stage) FIR filter bank is shown in FIG. 15.

One set of the requirements for this set of filter bank in z-domain is:

H(z)\tilde{H}(z⁻¹)+G(z)G(z⁻)=2 for “perfect” reconstruction and

H(z) \tilde{H}(−z⁻¹)+G(z)\tilde{G}(−z⁻¹)=0 for alias free reconstruction

### If the filter bank meets the wavelet construction requirements, then, for FIG. 15:

λ=scaling function coefficients
γ=wavelet function coefficients

When a discrete signal X is filtered by a highpass filter \tilde{G} and a lowpass filter \tilde{H} are downsampled, the result is a highpass signal HP and a lowpass signal LP, each containing half as many samples as the input signal X.

Low frequency components from the above output are treated as a new signal and passed through the same type of filter bank. This cascading process is repeated several times. At the end of this treatment, a very low frequency signal is retained. Together with the detail information for the different resolution levels, it represents the original signal decomposed in several resolution levels. This is called a forward wavelet transform. A three level decomposition for a one dimension (1D) forward WT filter bank is shown in FIG. 16.

To reconstruct the original signal, an inverse (or reverse) transform is used. In the inverse transform process, signals from HP and LP are upsampled and followed by filtering in highpass and lowpass filter banks. Finally, the outputs of the signals from the filters are combined through an accumulator to form the final filtered output signal. A three level reconstruction for a 1D inverse WT is shown in FIG. 17.

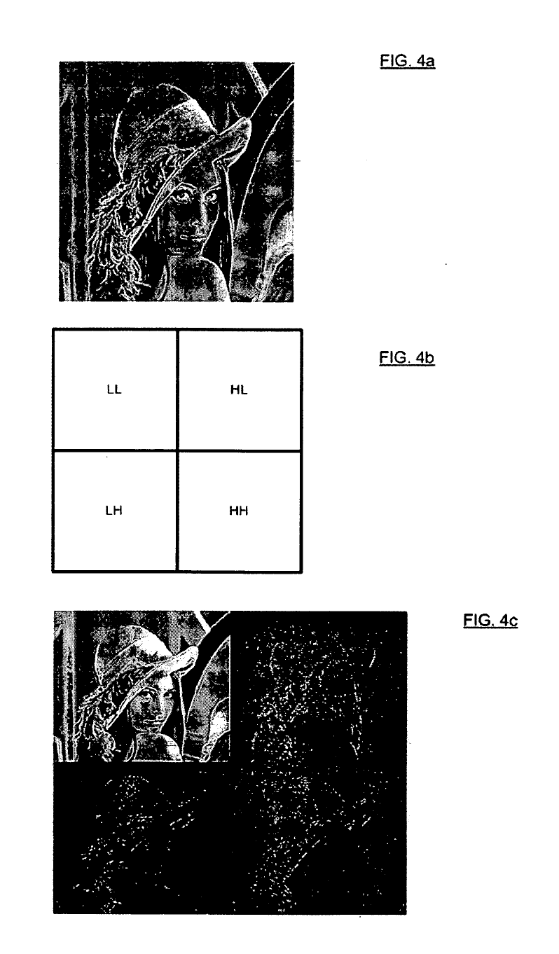

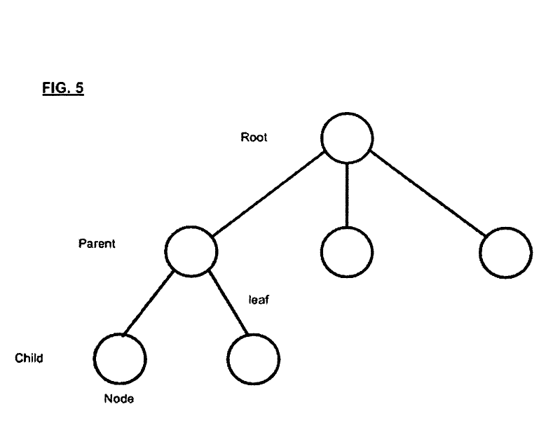

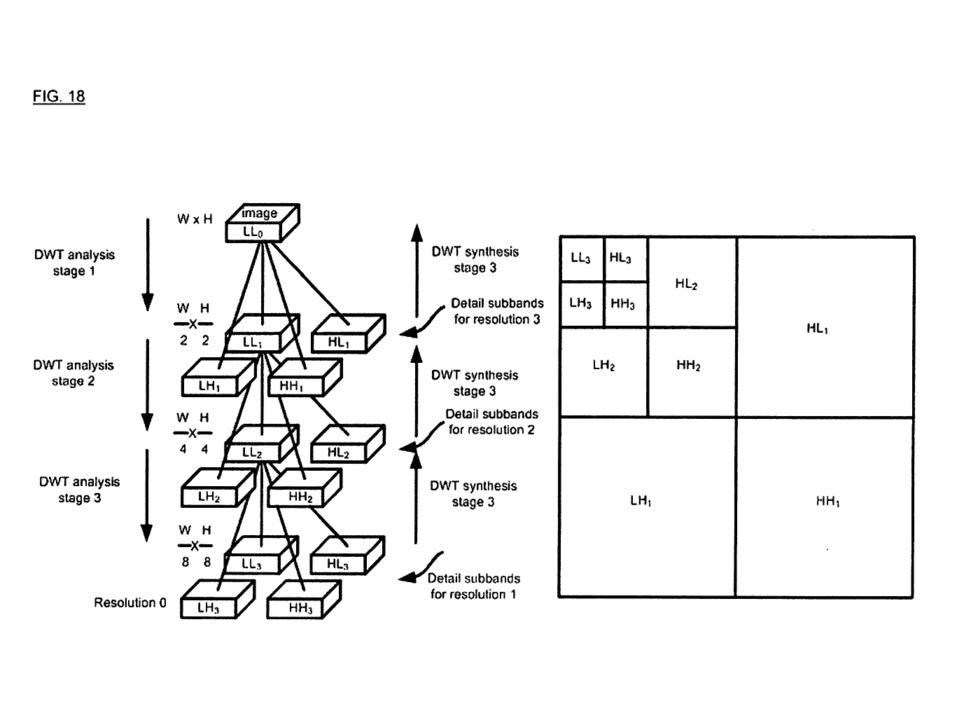

The 1D WT described can be extended to a two dimension (2D) WT using separable wavelet filters. With separable filters, the 2D transform can be calculated by applying 1D transform to the entire horizontal (rows) of the input and then repeating on all vertical (columns) of the input data. An example of one level 2D transform decomposition is illustrated in FIG. 4a to FIG. 4c. If the output of the high pass filter, g, and low pass filter, h, are represented as H and L respectively, then an application of the filters to a 2D image in horizontal and vertical directions produces four subbands labeled by LL, LH, HL and HH. Together, these four quadrants constitute a resolution plane and further decompositions can take place in the LL quadrant. An illustration of a three level 2D decomposition is shown in FIG. 18.

Different types of filters can be used to implement the WT, for example, the first generation wavelets such as Daubechies wavelet families, Coiflet wavelets, Meyer's wavelets, etc. and the second generation wavelets such as Cohen-Daubechies-Feauveau class biorthogonal wavelets etc. Any type of filter known to those skilled in the art can be used.

The implementation of WT, as shown in FIGS. 15 and 16 (i.e., filtering first followed by downsampling realization of WT), is inefficient. Half of the computed filtered output samples are discarded during the downsampling process. To maximize the efficiency of WT, subsampling preferably is done before filtering. To achieve this, a technique known as Lifting Scheme (Sweldens 98), LS, is used. In LS, only the even parts (or the odd parts) of LP and HP are computed as follows:

$$\begin{matrix}{LP}_{e} ( {z}^{2} ) = {[ H ( z ) X ( z ) ]}_{e} \\ = {H}_{e} ( {z}^{2} ) {X}_{e} ( {z}^{2} ) + {z}^{- 1} {H}_{o} ( {z}^{2} ) {X}_{o} ( {z}^{2} )\end{matrix}$$

$$\begin{matrix}{HP}_{e} ( {z}^{2} ) = {[ G ( z ) X ( z ) ]}_{e} \\ = {G}_{e} ( {z}^{2} ) {X}_{e} ( {z}^{2} ) + {z}^{- 1} {G}_{0} ( {z}^{2} ) {X}_{0} ( {z}^{2} )\end{matrix}$$

$$where$$

$$\begin{matrix}{X}_{e} ( {z}^{2} ) = \frac{X ( z ) + X ( - z )}{2} \\ = {\sum }_{k} {X}_{2 k} {z}^{- 2 k} \\ = even part of X ( z ) , and k ∈ I\end{matrix}$$

$$\begin{matrix}{X}_{o} ( {z}^{2} ) = \frac{z}{2} [ X ( z ) - X ( - z ) ] \\ = {\sum }_{k} {X}_{2 k + 1} {z}^{- 2 k} \\ = odd part of X ( z )\end{matrix}$$

$$and$$

$${H}_{e} ( {z}^{2} ) = even part of the filter H ( z )$$

$${H}_{o} ( {z}^{2} ) = odd part of the filter H ( z )$$

In matrix representation, the above can be rewritten as:

$$\begin{matrix}[ \begin{matrix}λ ( z ) \\ γ ( z )\end{matrix} ] = [ \begin{matrix}{LP}_{e} ( z ) \\ {HP}_{e} ( z )\end{matrix} ] \\ = [ \begin{matrix}{H}_{e} ( z ) & {H}_{o} ( z ) \\ {G}_{e} ( z ) & {G}_{o} ( z )\end{matrix} ] [ \begin{matrix}{X}_{e} ( z ) \\ {z}^{- 1} {X}_{0} ( z )\end{matrix} ] \\ = P ( z ) [ \begin{matrix}{X}_{e} ( z ) \\ {z}^{- 1} {X}_{0} ( z )\end{matrix} ]\end{matrix}$$

$$where$$

$$P ( z ) = polyphase matrix = [ \begin{matrix}{H}_{e} ( z ) & {H}_{o} ( z ) \\ {G}_{e} ( z ) & {G}_{o} ( z )\end{matrix} ]$$

and λ, γ are the wavelet filter coefficients for the given decomposition level, as shown in FIG. 15, FIG. 16 (Assuming (\tilde{G}, \tilde{H}),(G,H) meet the wavelet requirements (Soman 93)).

To obtain “perfect” reconstruction, the following invertible condition must be met (Vetterli 95)

\tilde{P}(z⁻¹)P(z)=I

In addition, the determinant of P(z) must have a value of one (“1”). This guarantees the matrix to be non-singular. A direct result of implementing this requirement will be that the corresponding filter pair, (H, G), satisfies the following condition:

Hₑ(z²)Gₒ(z²)−Hₒ(z²)Gₑ(z²)=1

Such filter pair (H, G) is complementary. In addition, if (H, G) is complementary, so is the filter pair(\tilde{H}, \tilde{G}). Such complementary filter pairs, constructed this way, can be shown to have a biorthogonal relationship:

\tilde{G}(z)=z⁻¹H(−z⁻¹)

\tilde{H}(z)=−z⁻¹G(−z⁻¹)

### For this embodiment of the invention, two default sets of biorthogonal wavelet filters used are the Daubechies 9/7 filter and the reversible LeGall 5/3 filter (Unser 03). Other optional biorthogonal wavelet filters can also be used.

The LeGall 5/3 filter pair can be described as follows:

$$- z \tilde{H} ( {z}^{- 1} ) = \frac{1}{8} {z ( 1 - {z}^{- 1} )}^{2} ( z + {z}^{- 1} + 4 )$$

$$H ( z ) = \frac{1}{2} {z ( 1 + {z}^{- 1} )}^{2}$$

The Daubechies 9/7 filter pair can be represented by:

$$\begin{matrix}- z \tilde{H} ( {z}^{- 1} ) = ( \frac{{2}^{- 5}}{\frac{64}{5 ρ} - 6 + ρ} ) {{z}^{2} ( 1 - {z}^{- 1} )}^{4} \\ ( {z}^{2} + {z}^{- 2} + ( 8 - ρ ) ( z + {z}^{- 1} ) + \frac{128}{5 ρ} + 2 )\end{matrix}$$

$$H ( z ) = ( \frac{{2}^{- 3}}{ρ - 3} ) {{z}^{2} ( 1 + {z}^{- 1} )}^{4} ( - z - {z}^{- 1} + ρ )$$

where ρ is the real root of

128−116x+40x²−5x³

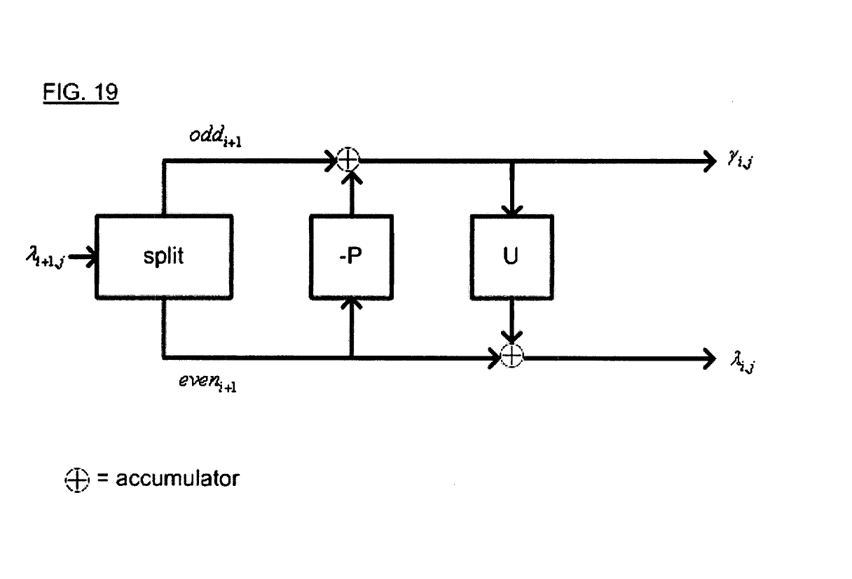

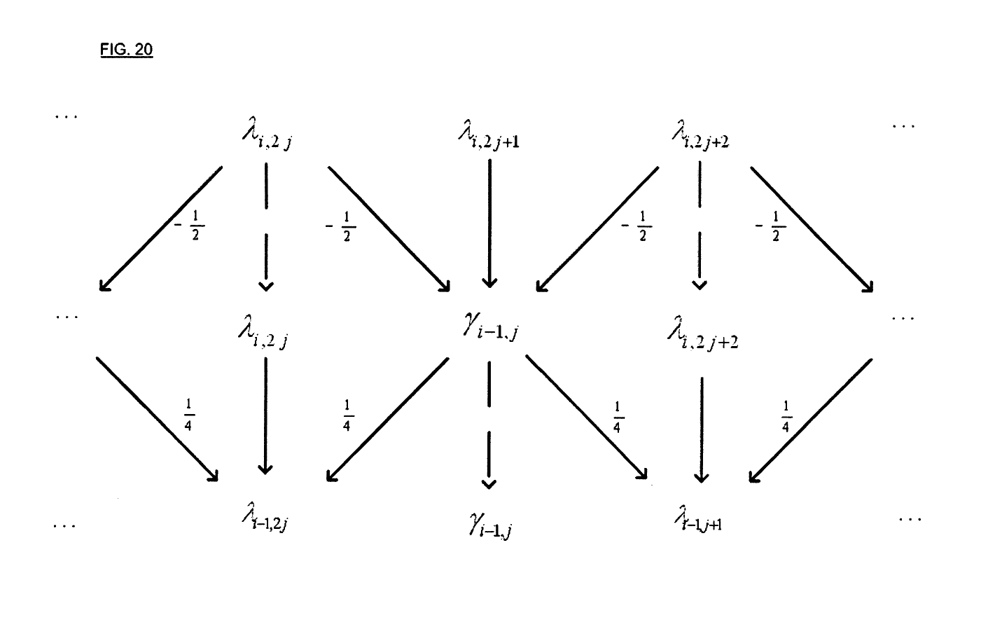

### There are three phases in Lifting Scheme, LS, for forward transform (Sweldens 95), as illustrated in FIG. 19:

1. Split (or Subsampling) Phase
2. Predict (or Dual Lifting) Phase, P
3. Update (or Primal Lifting) Phase, U

In the Split Phase, an input signal X(z) is split into its even and odd polyphase components, i.e.

X(z)=Xₑ(z²)+z⁻¹X₀(z²)

where
Xₑ(z²)=even part of X(z)=λ in FIG. 15, FIG. 16
Xₒ(z²)=odd part of X(z)=γ in FIG. 15, FIG. 16

To achieve this objective, LS employs Lazy Wavelet Transform, LWT. The polyphase matrix for LWT is

$${P}_{lazy} ( z ) = [ \begin{matrix}1 & 0 \\ 0 & 1\end{matrix} ]$$

From filter coefficients (or algorithmic) prospective, LWT maps odd and even input data sets into wavelet and scaling coefficients respectively.

γ_{-1,k}:=λ_{0,2k+1}

λ_{-1,k}:=λ_{0,2k}

(where negative indices have been used according to the convention that the smaller the data set, the smaller the index and 0 represents the original data level at resolution level 0. The operation “:=” denotes a subsampling operation.)

Because Xₑ and Xₒ vectors are highly correlated, after splitting, LS uses the even set Xₑ to predict the odd set X₀ using a prediction operator, P, in Dual Lifting Phase, as follows:
Let P (Xₑ)=predicted odd values
d=Xₒ−P(Xₑ)=difference or details of the signal (FIG. 15, FIG. 19)

From algorithmic prospective, the above 2 steps are equivalent to

γ_{-1,k}:=P(λ_{-1,k})

γ_{-1,k}:=λ_{0,2}k+1−P(λ_{-1,k})

Therefore, the wavelet coefficients, γ, generated through this lifting process, embodies the details or high frequencies of the image signal.

Construction of P is based on the complementary properties of the filter pair (H,G). By definition of Lifting Scheme (Sweldens 95), given one filter, e.g. H, its complementary filter, G^{new}, can be determined as

G^{new}(z)=G(z)+T(z²)H(z)

where T (z²) is a Laurent polynomial.

The corresponding polyphase matrix which defines this Dual Lifting operation is

$${P}^{new} ( z ) = ( \begin{matrix}{H}_{e} ( z ) & {H}_{o} ( z ) \\ {G}_{e}^{new} ( z ) & {G}_{o}^{new} ( z )\end{matrix} ) = ( \begin{matrix}1 & 0 \\ T ( z ) & 1\end{matrix} ) P ( z )$$

### Because the default biorthogonal wavelets (Daubechies 9/7 wavelets and LeGall 5/3 wavelets) used are known, hence, the unknown, T(z), Gₑ^{new}(z), Gₒ^{new}(z), can be determined.

The goal of Dual Lifting Phase is to encode γ from the difference between the odd indexed samples, λ_{0,2k+1} and the average of its two even index neighbors, λ_{-1,2k} and λ_{-1,k+1}. Algorithmically, this is represented by

$${γ}_{- 1 , k} \text{:} = {λ}_{0 , 2 k + 1} - \frac{1}{2} ( {λ}_{- 1 , k} + {λ}_{- 1 , k + 1} )$$

Thus wavelet coefficients, γ_{-1,k}, captures the high frequencies present in the original signal. To minimize inherent excess aliasing in the above formulation, the following smoothing condition is imposed on the scaling coefficients during this Dual Lifting operation (Daubechies 98):

$${λ}_{- 1 , k} += \frac{1}{4} ( {γ}_{- 1 , k - 1} + {γ}_{- 1 , k} )$$

FIG. 20 summarizes the relationship between the scaling and wavelet coefficients during this Dual Lifting Phase.

The dual polyphase matrix, for this Dual Lifting operation, at the analysis side (FIG. 15) is

$${\tilde{P}}^{new} ( z ) = \tilde{P} ( z ) ( \begin{matrix}1 & 0 \\ \tilde{T} ( z ) & 1\end{matrix} )$$

$$where T ( z ) = - \tilde{T} ( z ) .$$

The corresponding filter is represented by

\tilde{G}^{new}(z)=\tilde{G}(z)+\tilde{H}(z) \tilde{T}(z²)

During the Primal Lifting phase, through the use of the Update operator, U, d is combined with Xₑ to obtain the scaling coefficient, λ as follows:

λ=Xₑ(z)+U(d)=coarse approximation of the original signal X.

Thus, scaling coefficients, λ, embodies the coarse outline, or the low frequencies, information of the image signal.

Similar to Dual Lifting process, the construction of update operator U is done by determining H^{new} from G as follows:

H^{new}(z)=H(z)+S(z²)G(z)

where S(z²) is a Laurent polynomial.

The corresponding polyphase matrix that define Primal Lifting is

$${U}^{new} ( z ) = ( \begin{matrix}{H}_{e}^{new} ( z ) & {H}_{o}^{new} ( z ) \\ {G}_{e} ( z ) & {G}_{o} ( z )\end{matrix} ) = ( \begin{matrix}1 & S ( z ) \\ 0 & 1\end{matrix} ) U ( z )$$

$$where U ( z ) = ( \begin{matrix}{H}_{e} ( z ) & {H}_{o} ( z ) \\ {G}_{e} ( z ) & {G}_{o} ( z )\end{matrix} )$$

Because the biorthogonal wavelets (such as the default Daubechies 9/7 wavelets and LeGall 5/3 wavelets) used are known, hence, the unknown, S(z), Hₑ^{new}(z), Hₒ^{new}(z), can be determined from above.

The dual polyphase matrix at the analysis side (FIG. 15) is

$${\tilde{U}}^{new} ( z ) = \tilde{U} ( z ) ( \begin{matrix}1 & 0 \\ \tilde{S} ( z ) & 1\end{matrix} )$$

### And the corresponding filter is represented by

\tilde{H}^{new}(z)=\tilde{H}(z)+\tilde{G}(z)\tilde{S}(z²)

The polyphase matrix corresponding to a given decomposition level of the above forward transform can be represented by

$$P ( z ) = \underbrace{[ \begin{matrix}{K}_{1} & 0 \\ 0 & {K}_{2}\end{matrix} ]}_{normalization} {\prod }_{i = 1}^{m} \{ \overbrace{[ \begin{matrix}1 & {S}_{i} ( z ) \\ 0 & 1\end{matrix} ]}^{primal lifting} \underbrace{[ \begin{matrix}1 & 0 \\ {T}_{i} ( z ) & 1\end{matrix} ]}_{dual lifting} \}$$

Similarly, the polyphase matrix corresponding a given decomposition level of the above inverse transform can be represented by

$$\tilde{P} ( z ) = {\prod }_{i = 1}^{m} \{ [ \begin{matrix}1 & 0 \\ {T}_{i} ( z ) & 1\end{matrix} ] [ \begin{matrix}1 & {S}_{i} ( z ) \\ 0 & 1\end{matrix} ] [ \begin{matrix}\frac{1}{{K}_{1}} & 0 \\ 0 & \frac{1}{{K}_{2}}\end{matrix} ] \}$$

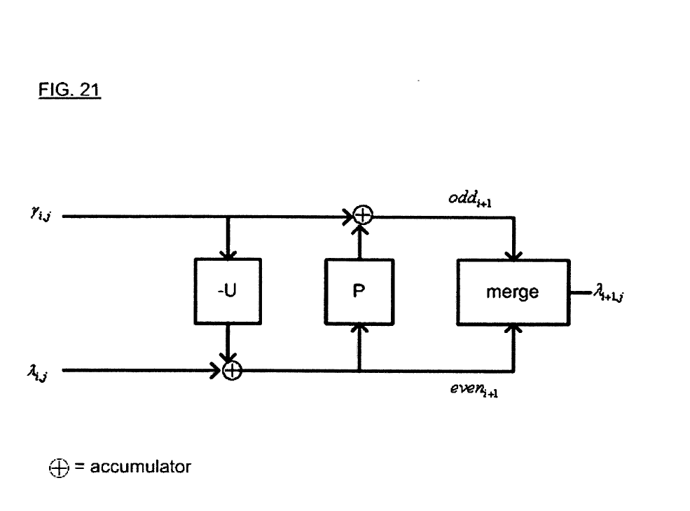

A schematic diagram of the inverse lifting transform can be found in FIG. 21.

In summary, implementation of wavelet transform used in this embodiment starts with a Lazy Transform to split up the input signal into odd and even parts. Then, Primal and Dual Lifting steps are applied to the Lazy Transform to obtain a new WT by using the even wavelet coefficient subset to predict the odd wavelet coefficient subsets. The entire process is applied repeatedly until the desired resolution properties are achieved.

The entire lifting transform can be done in place without the need for auxiliary memory because it does not need input samples other than the output of the previous lifting step. In general, input image data consists of integer samples whereas wavelet coefficients are real or rational numbers. Lifting Scheme can be adapted to integer-to-integer mapping by adding rounding operations at the expense of introducing nonlinearity in the transform. The result is a fast integer WT that is reversible, regardless of the quantization and encoding non-linearities. Both integer and floating point implementation of Lifting Scheme are used in this invention.

Nonlinearity error generated in the forward transform process can be eliminated in the inverse transform process in order to safe guard the perfect reconstruction concept. This can be explained as follows. During the Predict and Update processes, filter coefficients are scaled and rounded to integers. Integer arithmetic is used. Rounding of filter coefficients introduces some error, E, such that in the Forward Transform:

γ_{i,j,forward}=γ_{i,j,original}−{P(λ_{i,j})+E}

λ_{i,j,forward}=λ_{i,j,original}{U(λ_{i,j})+E}

where
γ_{i,j,forward}=output wavelet coefficient for sample j at resolution level i (FIG. 15)
γ_{i,j,original}=input wavelet coefficient for sample j at resolution level i (FIG. 15)
λ_{i,j,forward}=output scaling coefficient for sample j at resolution level i (FIG. 15)
λ_{i,j,original}=input scaling coefficient for sample j at resolution level i (FIG. 15)

The error E is fully deterministic because while calculating the inverse transform, the same error E is introduced. This error is eliminated in the reconstruction process as follows. For the Inverse Transform:

$$\begin{matrix}{γ}_{i , j} = {γ}_{i , j , forward} + \{ P ( {λ}_{i , j} ) + E \} \\ = {γ}_{i , j , original} - \{ P ( {λ}_{i , j} ) + E \} + \{ P ( {λ}_{i , j} ) + E \} \\ = {γ}_{i , j , original}\end{matrix}$$

$$\begin{matrix}{λ}_{i , j} = {λ}_{i , j , forward} - \{ U ( {γ}_{i , j} ) + E \} \\ = {λ}_{i , j , original} + \{ U ( {γ}_{i , j} ) + E \} - \{ U ( {γ}_{i , j} ) + E \} \\ = {λ}_{i , j , original}\end{matrix}$$

Consequently, the original data can be recovered exactly, which means perfect reconstruction of the original image.

Images generated by certain industry sectors such as satellite remote sensing, health care, arts and entertainment are intrinsically large in nature. Compression of such images or sequence of images with lossless or high quality compression schemes will reduce the demand for substantial large image data storage infrastructures, and facilitate the transmission of these image data over the bandwidth limited IP network.

For compressing sequential images, the type of chosen video file format generally dictates the compression format. Choice of mjpeg would imply DCT and choice of “mj2” would imply WT. Preferably, auxiliary video file format such as avi also is supported.

The end user can choose the Region Of Interest (ROI) he/she would like to retrieve through the GUI. The ROI can be the entire image or subsection(s) of the image. If no ROI is specified, the system will default to assume ROI is the entire image. If there are other related images located in the same location (for example a particular folder), the choice of ROI will propagate through the rest of the related images. A stack of these two dimensional ROI is collectively addressed as Volume of Interest (VOI) hereon in. If end user requests video generation of a related sequence of images, if ROI is chosen for the base image, the VOI also applies.

If a progressive compression mode is chosen, the end user can view the amount of image data received from the server immediately without waiting for the entire data set of the image to arrive at the client side. In other words, the user can view a lower resolution image based on the number of bits received and a full resolution of the image when all the bits are received.

For lossy compression, if the end users choice is a DCT based compression engine, a single image compression quality parameter will prompt user to specify a desirable compression value. If the end user chooses a WT based compression engine, a Compression Action List, CAL, will be presented for the user's input. Contents of CAL preferably, but not exclusively, includes the following:
1. Wavelet Type (3/7 wavelets or 5/9 wavelets)
2. Overall Compression Rate
3. Choice of colorspace for compression
4. Progression Order for the colorspace
5. Chromatic Offset for the image in use
6. Image Offset in display for the current image
7. Number of Tiles use for subdividing the original image
8. Tile Offset
9. Tile Dimension
10. Number of Resolution Layers for processing
11. Compression rate for intermediate layers resolution layers
12. Quantization Steps for preprocessing
13. Choice of bypassing Arithmetic Coding procedure
14. Codeblock dimension for Tier 1 processing
15. Precinct Dimension
16. Number of Guard bits in the final bitstream
17. Stream Marker Generation for the final bitstream

Preferably, the system will default to a set of preset values for the above parameters if no user input or no appropriate user input is detected. System assigned parameters are values from appropriate LUT. The LUT is formed by creating a database which acquires information through periodic adaptive learning using past history for the best image quality compression for the class of image used. This CAL is an “on demand” compressed image quality management instruction for the compressor.

Before a session ends, the end user preferably is asked to give subjective evaluation of the image quality of the image(s) received based on the MOS scale. This evaluation is optional and will be returned to the application server for QoS calculations as described herein.

The QoS calculations preferably use one or more quality factors, which provide objective image quality measurement guide lines. Preferred quality parameters include:
a. Mean Square Error
b. Peak Signal to Noise Ratio
c. Mean Absolute Error
d. Quantitative Pixel Difference
e. Root Mean Square Error

### Let:

x(i,j)=pixel value of the image sample at location (i,j) on the image plane
y(i,j)=pixel value of the reference image sample at location (i,j) on the image plane
M=width of the image
N=height of the image
Maxₓ=maximum value of test image sample

Then, the above quality parameters are defined as follows.

$$MSE = \frac{1}{M \cdot N} {\sum }_{i = 0}^{M - 1} {\sum }_{j = 0}^{N - 1} {[ x ( i , j ) - y ( i , j ) ]}^{2}$$

$$PSNR = 10 {log}_{10} ( \frac{{Max}_{x}^{2}}{MSE} )$$

$$MAE = \frac{{\sum }_{i = 0}^{M - 1} {\sum }_{j = 0}^{N - 1} \vert x ( i , j ) - y ( i , j ) \vert}{M \cdot N}$$

$$RMSE = \sqrt{\frac{{\sum }_{i = 0}^{M - 1} {\sum }_{j = 0}^{N - 1} {[ x ( i , j ) - y ( i , j ) ]}^{2}}{M \cdot N}}$$

The user can choose one of the above parameters as the lossy compression image quality control. If no parameter is chosen, the default parameter is used. Preferably, the default parameter is PSNR (Rowe 99). Except for Quantitative Pixel Difference, which is provided in a lookup table (LUT) of sample differences, all other error measuring parameters are floating point numbers.

The Application Server Layer 20 manages data resources accessing and distributing rules. It authenticates the identities of the remote users and local users preferably through different levels of encryption depending on the origin of the calls against its local database. The application server preferably exercises business logic pertaining to the licenses of the legitimate end users as well as maintenance of information transaction security. This may include the level of access to the image database resources, the number of times of access permitted a legitimate user can have during a period of time, etc.

The server continuously monitors incoming messages from local users and over the IP. When a query message from a user is intercepted, the server authenticates the validity of the user (e.g., IP address) against a list of authorized clients. For queries from authorized users, the server parses the requests from the client to determine the course of actions. A list of exemplary action items the server parses may include:
a. the name and identities of the image data requested.
b. for some image data, the name and identities of the image data are encrypted. It is the job of the server to decrypt this request.
c. specifies if compression is needed.
d. type of compression format desired.
e. transcoding of image compression request from one image format to another if needed.
f. values of parameters such as compression ratio, bit rate information, number of preferred image tiles, number of quality layers in the compression action list requested by the client.
g. the ROI/VOI of the image(s) the client requests.
h. the designated directory within the client's terminal (or device) to which the end result should be forwarded.
i. the security of the resultant image(s) i.e. should it be encrypted, watermarked.

This list may be called the Transaction Action List, TAL.

The application server preferably maintains the connection of all the users currently in session and routes the requested image data from the database storage layer back to the corresponding client. The application server monitors the current system resources such as bandwidth availability. All current in session users are monitored sequentially. If available bandwidth or other system resources is/are exceeded, additional users are placed in a queue. When available resource is detected, for example, end of session has been successfully carried out for an in session user, the server connects the next available user(s) in the queue using First In First Out (FIFO) methodology.

The application server parses the input queries of the client and passes the queries to the appropriate database management tier through a worker thread. Each worker thread receives an allocated segment of the system resources to handle the return image files/folder, video file (if present), meta information pertaining to the image or compression system etc. Then, the application server moves on to service other incoming clients in a similar fashion. Preferably, the operating system for the application server provides an apparently continuous connection for each user being serviced.

The system continuously monitors each thread sequentially for return messages from the database tier. This information is forwarded to the appropriate client user requesting the information. When the process is done, the application server releases the system resources for other users and preferably updates the server's database to record the client usages and system traffic at time of usage. The application server preferably also monitors the system traffic to see if it strays away from a certain profile such as Poisson traffic pattern and takes appropriate actions to control the traffic throughput to fit this pattern.

In this embodiment, the database server 30 has two components: the data storage segment and the compression segment. The data storage segment preferably is managed and supervised by an enterprise database suite which manages the workflow. It links directly to the hardware based storage devices, such as RAID disk arrays, optical storage drive arrays. This data storage aspect is collectively addressed as the “database.”

For data storage, the database server preferably divides separate system resource pools for handling two different types of incoming requests for storage. The request types are linked to the compression engine in different manners. Once a type of request for retrieval of stored image related data files originates from the client side, the middle tier management passes the parsed queries from the client to the database server. So, with respect to the database server, the application server handles all the information traffic between itself and the client. There is no direct handshake between these two abstraction layers (i.e., the client server and the database server). Once the query of the client from the application server is intercepted, the database server allocates a segment of the available system resource for this request to a the worker thread. The worker thread continuously monitors for updates of this request from the application server. Before handing off the system resources and executables to the worker thread, the database server preferably first ensures the identities of the image file(s)/folder(s) from the client.

The database server searches the database to look for a match of image data files/folders to the request. If found, the corresponding worker thread preferably returns pointer(s) to the thumbnail(s) of the requested file(s)/folder(s) to the application server. The application server forwards this set of snapshots or thumbnails to the client. The worker thread of the database server preferably will continuously monitor for feedback of the information transmitted to the client. If a predetermined time has elapsed and no response has been intercepted from the user, the worker thread will request a response from the same end user on the client side. If no response from the same user after a predetermined period of time, the worker thread preferably terminates itself and releases its allocated system resources back to the system.

If the client confirms the thumbnails of the file(s)/folder(s) and responds to the application server the details of compression for these file(s)/folder(s), this information will be transmitted to the database server via the middle tier. The details of the information may include identities of the image files/folder requested, compression information on the CAL, the parameters in the TAL, ROI/VOI information, video (cine loop) generation request, video (cine loop) format, frame rate selection parameter, MOS assessment, etc. From hereafter, the above qualities are generically referred to as the parameter list. If any of the above information in the parameter list is required but is missing from the client side, default settings of these parameters from the system LUT for the type of imagery involved will be used.

This parameter list together with the corresponding file(s)/folder(s) are forwarded to the compression engine in the database server layer 30. The compression engine parses the parameter list and performs the compression as instructed. The desired amount of compression specified by the end user on the client side is parsed in the database server. If no value is specified, preferably, a default compression ratio or a best compression ratio corresponding to the image type and image source of origin stored in a dynamically trained look up table (LUT) will be used instead.

A recommended compression ratio lookup table preferably resides in the compressor or an associated memory. The table classifies image types based on the source of origin of the image or the methods of generation of the images and precompiled statistical records of compression ratio for the various types of images currently stored. The result of this table is a set of templates of recommended compression ratios that statistically provides the best compression ratio with regards to the resultant compressed image quality for the corresponding classes of images if the image data are chosen to be compressed in lossy mode. This look up table is not used for lossless compression mode.

For each compression performed, preferably, image quality of the compressed images against the original images will be measured. The result will be gauged against the acceptance threshold value in the parameter list set by the client. If compressed quality is below the threshold, the compression ratio set by the client will be overruled and the compression ratio is lowered by a predetermined increment from the performance record residing at the database server. The previous underperformed image is discarded and a compression along with the new compression ratio is performed. This preferred embedded image quality measurement and the compression engine are programmed in a feedback loop. The number of times the compression ratio needs to be readjusted depends on the availability of the system resources and amount of through traffic. This adaptive learning process preferably is incorporated with the compression engine and stored in a LUT at the database server.

If the desired compressed image quality fails to achieve after a specified number of compression iterations by the feedback loop, the feedback loop will terminate and the lossless compressed image file(s) residing at the database will be returned to the client instead.

When a video clip (or cine loop) of the compressed image files are requested, a video clip with the specific frame rate and format of the compressed images will generate.

Compressed image(s)/folder(s), preferably together with the corresponding metadata, are forwarded to the application server (which will be redirected to the original client server requesting this information in a separate system resource process). When done, the worker thread returns the system resources back to the system. The compression ratio used and corresponding image quality metrics for the requested image set preferably will be recorded together with the origin of the image type for statistical profiling purposes.

Another type of request for database resources originates from an image generating source. Image generating sources are usually associated with the hardware that records/captures the image in appropriate formats or they can be images or sequences of images from an image warehouse. Typically, the service requested by an image generation source is for permanent storage. The configuration for this type of service at the database server is usually performed normally at system start up and subsequently when other changes to these specific hardware based system(s) are made.

In this embodiment, there are three storage options for system administrators, to be implemented on the image storage server. These options are Lossless Compression, Lossy Compression or no compression. The system default storage mode is Lossless Compression for these original image data. The image data source has the option of compressing in lossless mode before transmitting the data to the secure application server. If no compression mode is chosen, incoming data is recorded to the database without alteration. If a compression mode for storage is chosen when archiving the data, the system preferably can compress further the image data prior to transmission to an end user on request for that image data, providing the desired image quality permits it.

A distinctive feature of this invention is the on-demand switchable compression schemes available to the user. A user can choose a balanced tree based compression encoder, namely SPIHT method, for compression or the user can choose an adaptive block coding base compression encoding method, EBCOT.

Set Partitioning in Hierarchical Trees (SPIHT) (Said 96) and Embedded Block Coding with Optimal Truncation (EBCOT) (Taubman 00) are image entropy encoding schemes that support progressive image transmission.

A given image is divided into tiles. An undivided image has only 1 tile—the entire image itself After tiling, the image is decomposed into a sequence of wavelet coefficients via two dimensional lifting wavelet transform (Sweldens 98). Integer based reversible LeGall 5/3 filter for lossless compression and Daubechies 9/7 floating point irreversible filters for lossy compression (Unser 03) preferably are used in this WT process to decorrelate the image information for this invention. The wavelet coefficients ensemble generated in such fashion is forwarded to a quantizer. A quantizer identifies, assembles large wavelet coefficients and discards coefficients that are deemed to be insignificant. After quantization, the generated bitstream still is related statically. To exploit this relationship in order to compress image data further, image entropy coding is used. The goal of image entropy encoding is to minimize the bit rate representing the image. Bit rate represents the average number of bits required to encode an image.

A tree is a type of data structure (FIG. 5). A non-empty tree structure has branches terminating in nodes (Ammeraal 98). Each node can have more branches (each branch is known as a “child” or “offspring”) terminating in nodes as well. A node that has a child is called a “parent” node. A child can have at most one parent. A node without a parent is called a “root” node and a node without a child is called a leaf node. All nodes within the tree structure are linked via some mechanism such as link list. Ideally, a tree is balanced. A tree is balanced if each node has a left and a right subtree in which the number of nodes differ by at most one. (Ammeraal 98)

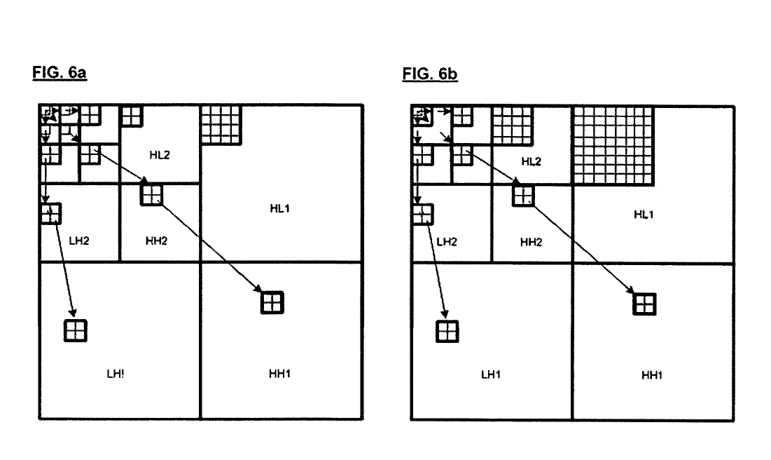

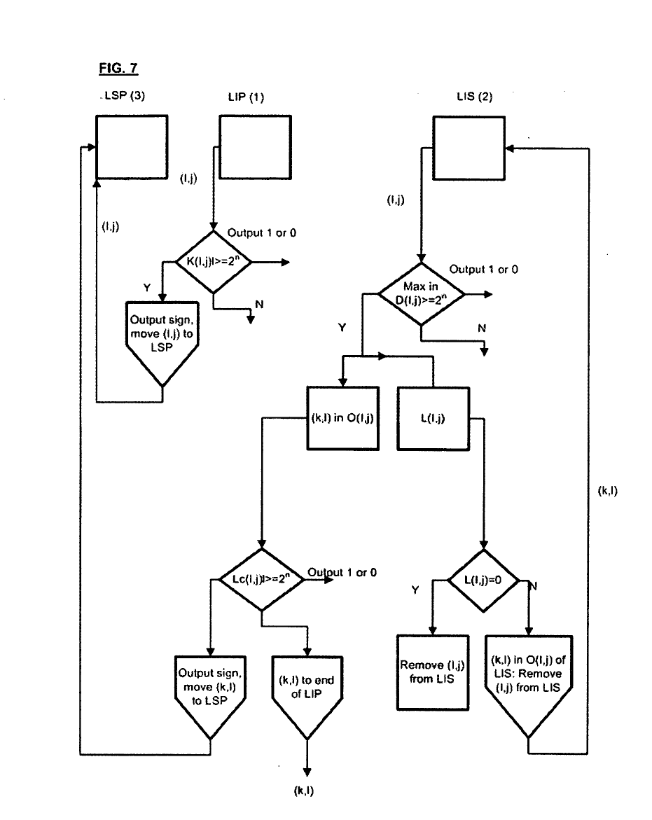

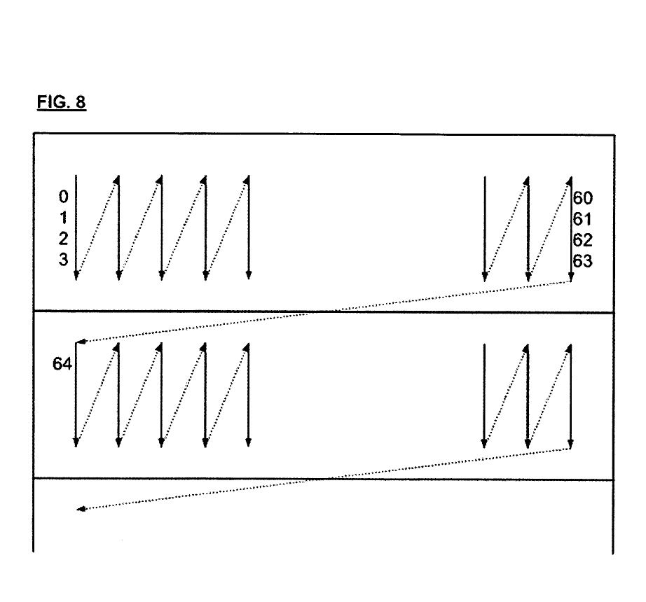

SPIHT is a spatial orientation tree algorithm that exploits spatial relationships among wavelet coefficients in different decomposition subbands (Said 96). SPIHT is a modification of Embedded Zero Tree (EZW) of Shapario (Shapiro 93). It defines parent-child relationships between the self-similar subbands to establish spatial orientation trees. The differences in the parent-child relationship for SPIHT and EZW are shown in FIGS. 6a, 6b.

SPIHT employs a balanced spatial orientation tree structure. All nodes correspond to a specific wavelet coefficient. Each node has either four offspring (child) or do not have any offspring (child). SPIHT classifies wavelet coefficients into 3 categories:
a. List of Insignificant Pixels, LIP
b. List of Significant Pixels, LSP
c. List of Insignificant Sets, LIS
   where
LIP: consists of coordinates of the coefficients which are insignificant with respect to the current threshold, T
LSP: consists of coordinates of the coefficients which are significant with respect to the current threshold, T
LIS: consists of coordinates of the roots of insignificant subtrees

### The threshold, T, is set to a value

2^{└log}^{₂}^{(max}^{_{(i,j)}}^{{|c}^{_{i,j}}^{|})┘}

and then successively decreased by a factor of two in each pass of the algorithm. In the above expression, c_{i,j} represents the wavelet coefficient at coordinate (i,j).

Each member of LIS is further classified as either Type A or Type B
Type A=member of LIS that represents D(i,j)
Type B=member of LIS that represents L(i,j)
   where
O(i,j), D(i,j) and L(i,j) are defined as:
O(i,j)=set of wavelet coefficients of the child corresponding to the node at location (i,j)
D(i,j)=set of all descendants of the wavelet coefficient of node at (i,j). (“descendant” is defined as offsprings, offsprings of the offsprings, etc.)
L(i,j)=D(i,j)−O(i,j)=set of coordinates of all the descendants of the coefficients of node at (i,j) except for the immediate 4 offsprings of the coefficient at location (i,j)

A SPIHT algorithm can be divided into
a. Initialization
b. Sorting Pass
c. Refinement Pass

A flowchart for a SPIHT algorithm is illustrated in FIG. 7 (see Banister 01; Said 96). During the initialization process, the ordered lists LIP, LIS, LSP are populated and the maximum number of wavelet coefficient, kₘₐₓ, is determined. kₘₐₓ is the upper limit the sequence Sorting Pass and Refinement Pass will traverse. All bitplanes above kₘₐₓ are ignored.

During the Sorting Pass, the algorithm reshuffles, adds and removes data members from the current LIP list into LIP, LSP and LIS ordered lists. Root nodes have a higher likelihood to be significant than the rest of the tree, so they undergo a separate significance test. After processing each set of wavelet coefficients in LIS, a refinement pass is performed where the most significant bit of |C_{i,j}| is output. Coefficients that have been added to LIS in the current pass are ignored.

The output stream from SPIHT is entropy coded with the adaptive arithmetic coding algorithm of Witten (Witten 97).

An EBCOT algorithm is used to generate a compressed bitstream from the quantized wavelet coefficients. Coefficients in each subband are partitioned into a set of rectangular codeblocks such that
a. nominal height and width of code block must be an integer power of 2
b. product of height and width<4096
c. height>4
   Block coding of EBCOT consists of two stages: Tier 1 Coding and Tier 2 Coding.

In Tier 1 coding, bitplane coding of the wavelet coefficients and context based arithmetic coding for compression is performed. Packetization of the output from compressed bitplane coding passes is referred to as Tier 2 coding.

Bitplane is a binary array of bits from all wavelet coefficients that has the same significant (i.e. resolution) level. All subbands from WT are subdivided into square code segments known as codeblocks. Each code block is independently coded starting with the most significant bits, MSB, and progressing to the less significant bits, LSB.

Bitplane coding uses 4 primitives to classify the significance of each sample. These primitives are:
a. Significant Coding: sample is not yet significant
b. Sign Coding: sample becomes significant
c. Refinement: sample is already significant
d. Run Length Coding: when sample and all its neighbors are insignificant

In Tier 1 Coding, codeblocks are independently coded using bitplane coder. The bitplane coder preferably uses three coding passes to scan from MSB to LSB. They are:
a. Significant Propagation Pass, SPP
b. Magnitude Refinement Pass, MRP
c. Cleanup Pass, CP

SPP encodes any sample that is currently insignificant and at least one of its eight immediate neighbors which is significant. Context is dependent on the significance of its neighbors and the subband in which the block is in. Context is used in the arithmetic coder. MRP encodes any sample that has become significant in a previous bitplane. Context is dependent on the significance of the neighbor and whether this is the first refinement bit. CP encodes all the remaining samples left over from the first two passes. Context is dependent on the significance of the neighbors and the run length. Within each bitplane, every 4 rows form a strip. Data from each strip is read from top to bottom and from left to right as shown in FIG. 8.

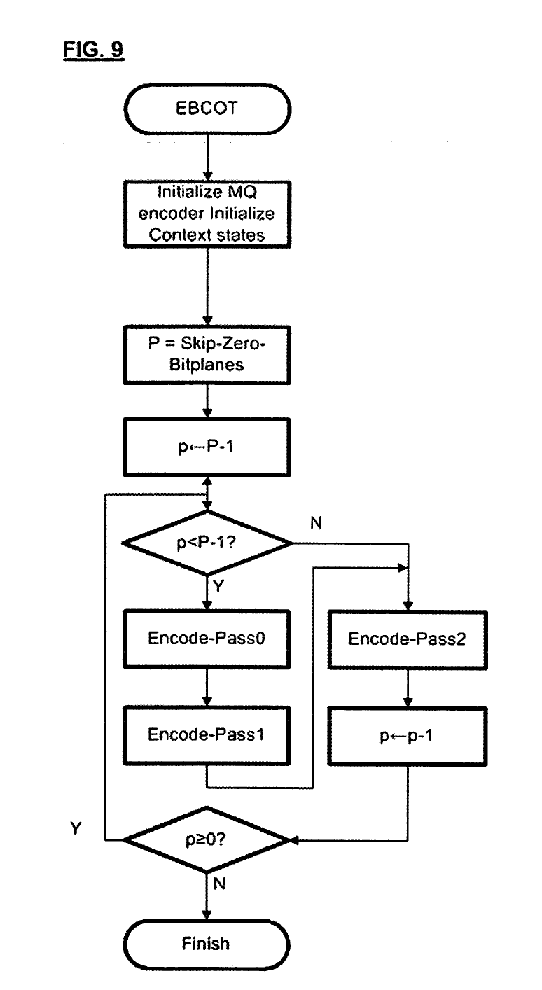

Tier 1 coding employs context dependent binary arithmetic coding with the use of the MQ coder (Marcellin 00). MQ coder has all the properties of a Q coder plus a conditional exchange procedure derived from the MELCODE and a state transition table known as JPEG-FA (Ono 89). A flowchart for Tier 1 coding is shown in FIG. 9.

In Tier 2 coding, the compressed bitstream generated from Tier 1 is organized into packets to form the final codestream. The codestream consists of a series of connected packets and special marker segments. A packet is a continuous segment in the codestream. Each packet consists of a number of bitplane coding pass for each code block in a precinct.

A packet represents the quality increment layers for each resolution level at a given spatial location.

Rate scalability is achieved through L number of resolution layers. Each coding passes is either assigned to one of the L layers or discarded. Coding passes containing the most important data are included in the lower layers while the coding passes associated with finer details are included in higher layers.

A precinct is a partitioned rectangular region consisting of a group of code blocks for all subbands at a particular resolution level.

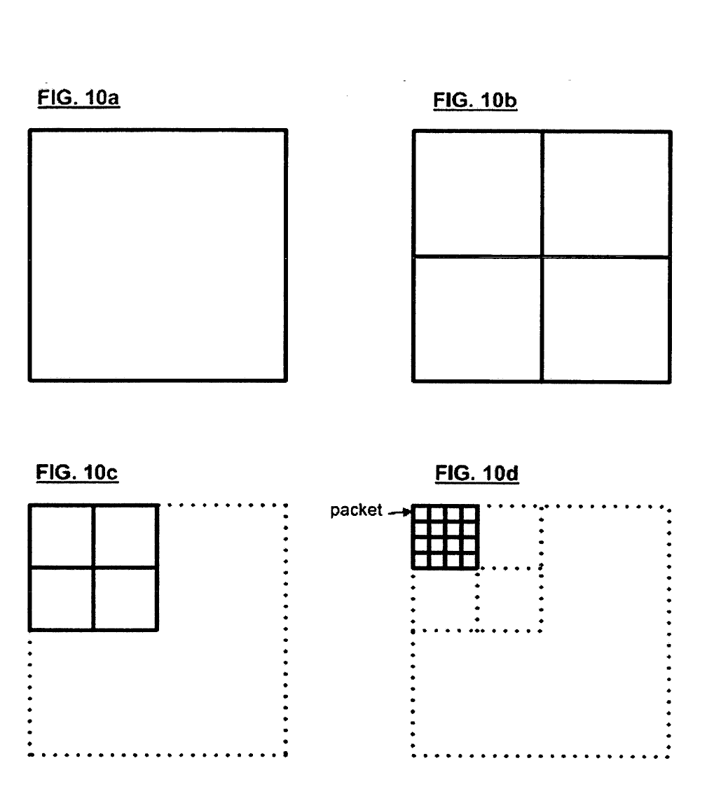

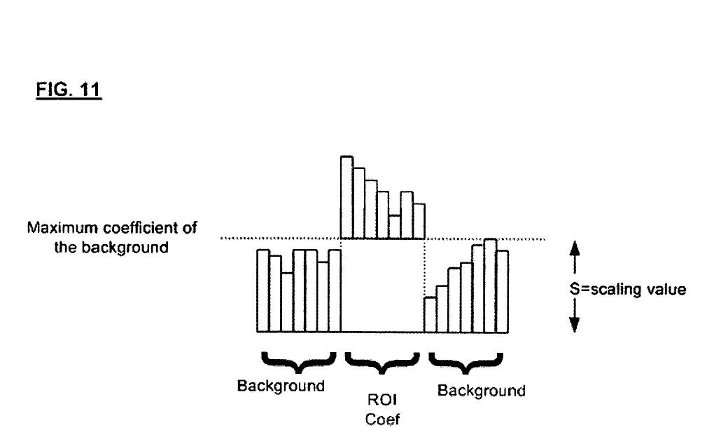

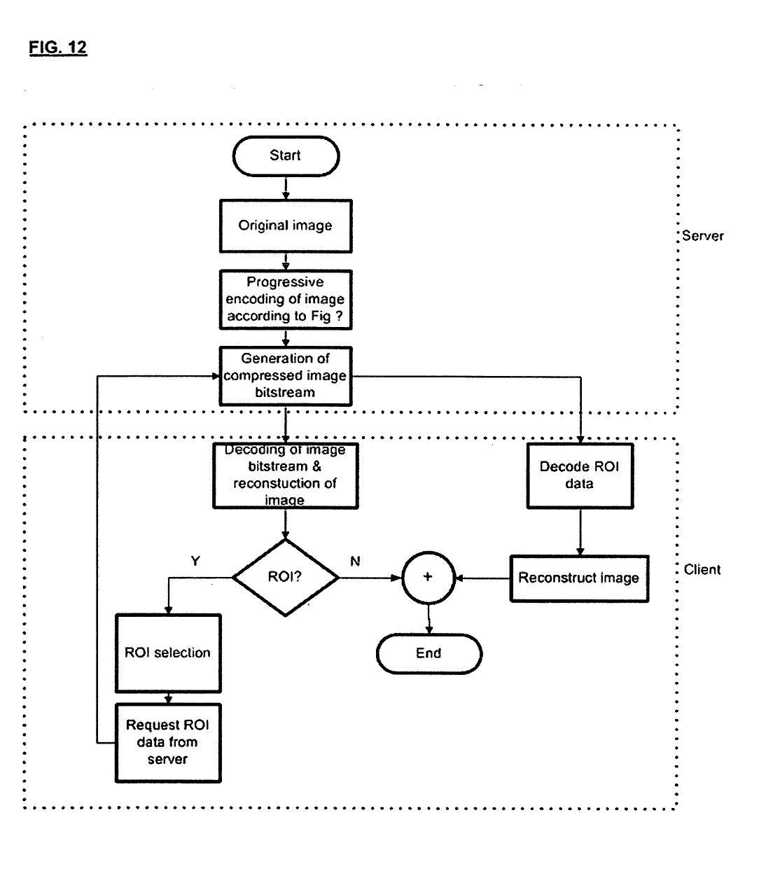

Packets from each precinct at all resolution levels in a tile are combined to form the final codestream. FIGS. 10a-10d show the relationships between the image tile, subband decomposition into precincts, codeblock subdivision of a precinct and packetization of the codeblock.

In both SPIHT and EBCOT models, the decoding process is the reverse of the above processes.

The compressed codestream is decoded via tree based SPIHT or embedded codeblock based EBCOT. The result is dequantized and inverse wavelet transformed is performed. The image data is post processed to reconstruct the original image.

Region of Interest, ROI, is a sub-segment of an image which contains special interest information to an end user. In this invention, ROI is implemented with MaxShift method.

MaxShift algorithm encodes ROI at higher bit rate, hence better image quality, than the rest of the image. (Christopoulos, 00)

MaxShift method finds the largest coefficient in the background area and places the interest area in a higher bitplane than the largest coefficient from the background area.

Let C_{b} be the largest wavelet coefficient in the background after quantization and s is a scaling factor such that s≧max (C_{b}).

ROI mask transformation is defined as

$$M ( i , j ) = \{ \begin{matrix}1 , & insideROI \\ 0 , & outsideROI ( i . e . background )\end{matrix}$$

Within the encoder, M(i,j) convolves with the image. Wavelet coefficients within the ROI are scaled up by a factor of “S” as shown in FIG. 11.

Mean Opinion Score (MOS) is a subjective evaluation of image quality through the inputs from the clients. The scale of evaluation is as follows (Oelbaum 04):

| Rating | Description |
|---|---|
| 5.0 | Imperceptible |
| 4.0 | Perceptible, but not annoying |
| 3.0 | Slightly annoying |
| 2.0 | Annoying |
| 1.0 | Very annoying |

To objectively gauge the compression image quality, parameters such as PSNR, MSE, MAE, PD and RMS are used in this invention as well. If client chooses not to input a particular mode of image quality measurement, the system defaults this operation to PSNR mode as part of the QoS process.

To enable compress once and multiple recompress format paradigms, the compression parameter choices offered to the administrator are different from the client side. For compression operation, the system administrator may ask for input of desired bitrate, compression ratio, number of tilings, number of quality layers etc. that are appropriate for the compression engine chosen.

Upon completion of the compression process, the current compression bitrate, compression ratio, various compression image quality measurement parameters as well as the MOS value(s) from the end user for the corresponding image(s) preferably are collected and stored for statistical analysis. The availability of MOS in the system depends on the participation by the end user.

A set of objective compression image quality measurement parameters, such as set forth above, and the subjective MOS (if available) values preferably are mapped regressively to the compression bit rate or equivalently, the compression ratio. This information is stored to a LUT for quality analysis. The LUT categorizes the incoming data based on the types of image origin and the hardware source from which these images were generated. For each category of image, a statistical profiling of the optimal compression ratio/compression bit rate distribution with respect to the corresponding image error metrics is performed. Statistical mean and standard deviation are obtained, confidence intervals are tabulated and a statistical significance test is performed. The best available compression ratio preferably is determined with the confidence level set by the administrator. Once the optimal compression ratio is determined, the system will update this information to the LUT. This is an adaptive learning mechanism for the system. Preferably, this is the system default mode of operation. A predefined default compression amount preferably is placed in the system at the time of first use.

The user can opt not to use this default value by specifying a specific degree of compression tailored to his/her needs. If no value is specified on the client side, the system default mode is used. Generation of this statistical based LUT for accumulated values is computationally intensive process. Preferably, it is done only periodically, as set by the administrator.

The compression engine (compressor) preferably resides in centralized database server as well as in the image generation/capturing devices.

The compressor on the server side provides services to the two groups of clients. One type of client usually requests image files to be stored in the centralized database server. They add new data to the enterprise storage. The other type of client usually requests information to be retrieved or viewed over a secure network. The compressor can compress the image in lossless mode and in lossy mode. If lossy compression service is requested, the compressor engine requires information regarding the amount of compression. This information manifests itself as a combination of the compression ratio (or the bit rate); the number of quality layers and the number of tilings and other related compression information in the transaction action list, TAL. Selection of these parameters will affect the final image/video quality of the compressed image(s)/video.

The compressor on the image generation/capturing devices provide the sole purpose of offering various available compression alternatives to the user prior to transmission to the receiver of the image. The compressor also offers a lossy or lossless compression facility. The default is lossless compression unless overridden by user with proper authorization. If lossy compression is permitted, the compression parameter list will be provided for the user.

When a compression request is received, the compressor will initiate the compression engine. Only the specified ROI/VOI of the image data will be compressed. When the image data comes from the image source (or image generator side), ROI/VOI is fixed to be the entire image. Otherwise, it is the ROI/VOI information when requested from the client side. A flowchart for this architecture is illustrated in FIG. 12.

The centralized image compressor preferably consists of four main modules: the preprocessing unit, the wavelet transform unit, the sequential quantization unit and an entropy encoding unit. Component transform takes place in the preprocessing unit. Input image data are normalized by DC shifting. Spectral redundancy removal of the color space is performed.

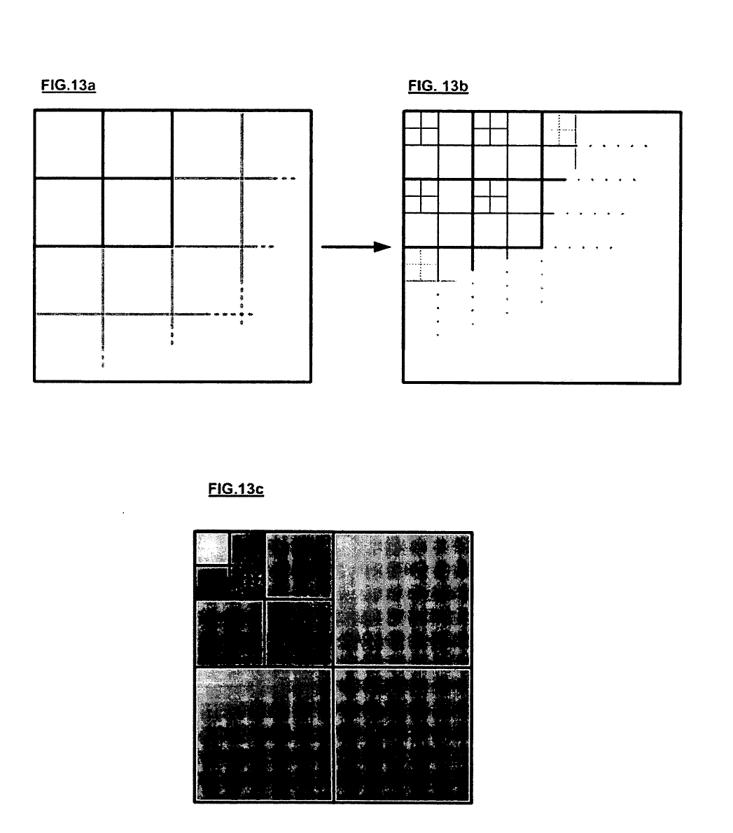

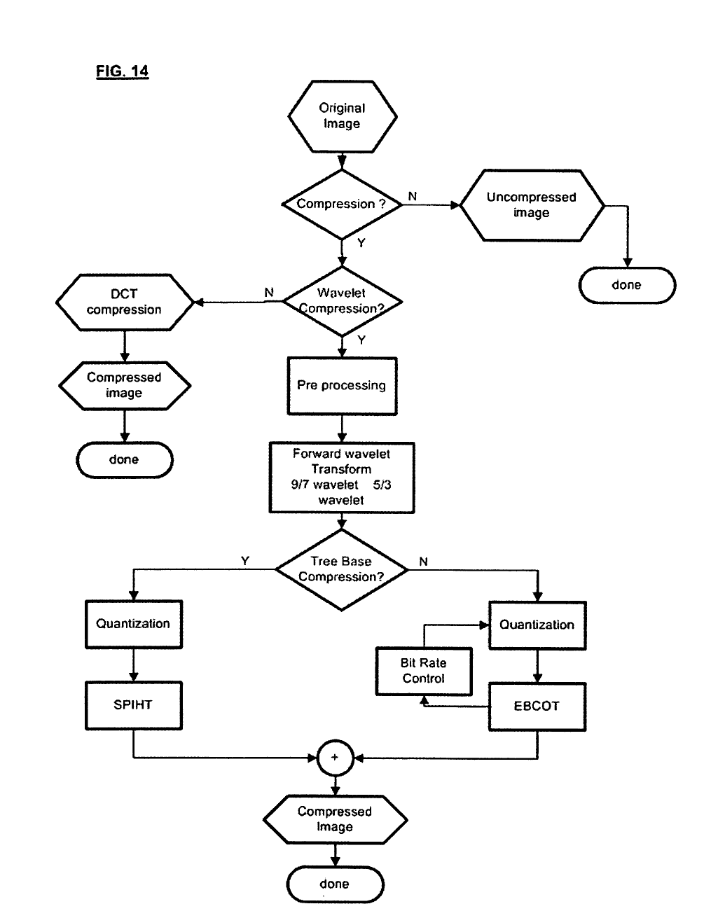

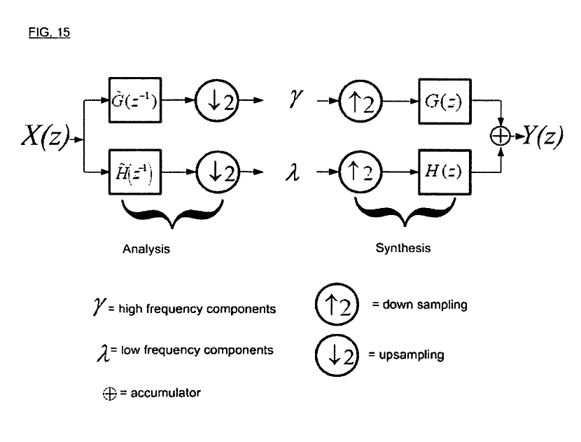

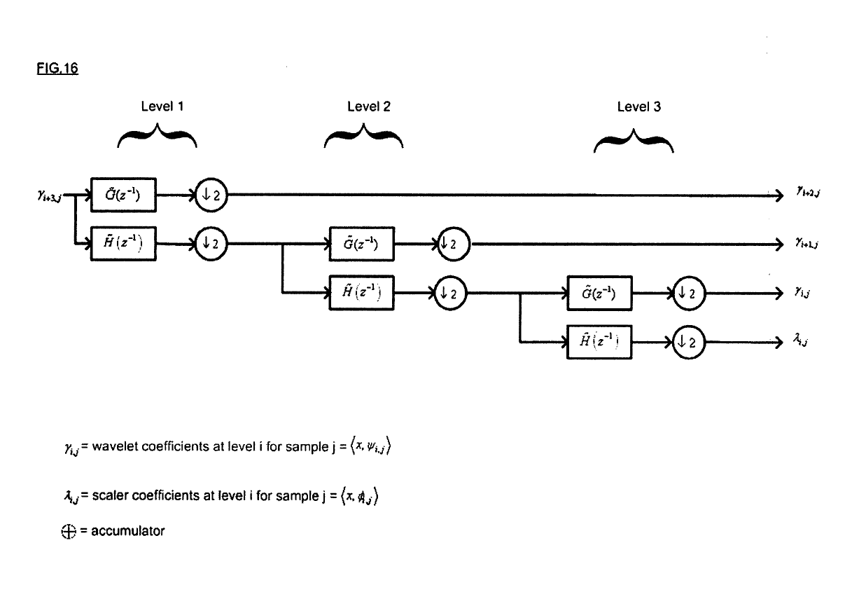

An input image is subdivided into rectangular non-overlapping blocks (tiles)—tiling process. All tiles are of uniform dimension of n×n blocks (where n is the number of image pixels) with the exception for the tiles located at the end of the image where boundary of the image prohibited such geometric division. Tiling is optional and tile size can be adjusted by user as part of the input parameter (FIG. 13a). The default value for the number of tiles is one.

For computational efficiency and efficient memory management, the Lifting Wavelet Transform preferably is used (Sweldens 98). Each tile is decomposed into subbands of coefficients by Lifting Wavelet Transform (FIGS. 13b, 13c).

For the lossy mode, preferably 9/7 wavelet transform filters are employed. 5/3 and 9/7 wavelet transform filter preferably are used for both lossless and lossy compression mode.

A scalar quantization is used to quantize the subband coefficient. If lossless compression mode is requested, no quantization is used. Bit precision of the input image dictates the quantization step size when operating under lossy compression mode.

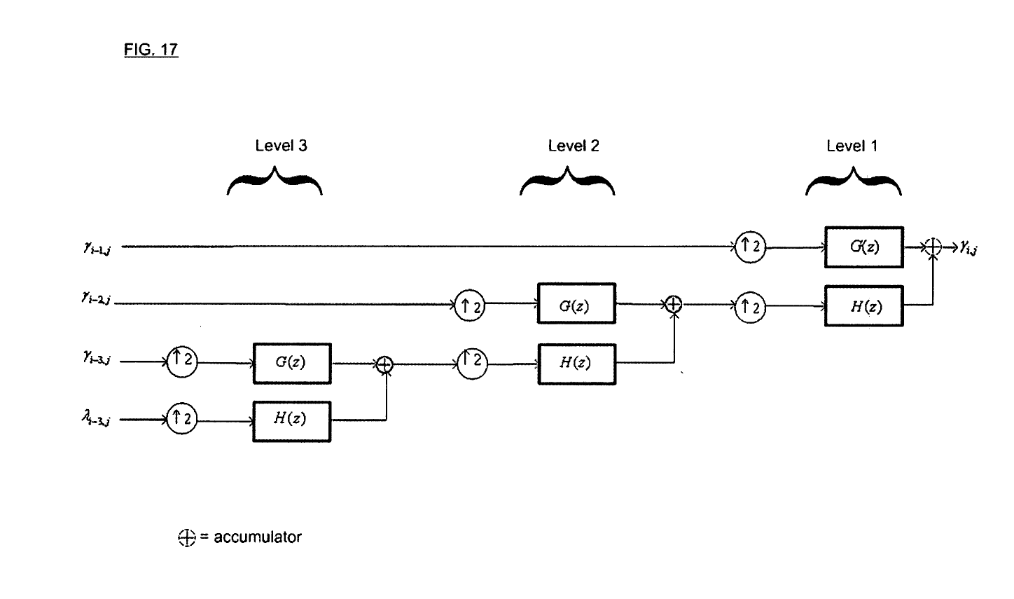

The Entropy encoding procedure is as follows. For this embodiment, depending on the choice of compression scheme chosen, the compression can either go through the route A which uses a tree base compression method SPIHT or route B which uses a context based code block encoding method EBCOT (FIG. 14). Both of these coding schemes support progressive transmission.

Specific region(s) within an image can be coded with higher resolution than the rest of the image (the background). This capability is embodied in the concept of ROI. A MaxShift algorithm is used to implement this feature. The MaxShift algorithm repopulates the associated bits within the ROI region(s) to higher bitplanes, thus, resulting in higher resolution (FIG. 10). The MaxShift algorithm works in both SPIHT and EBCOT generated wavelet domains.

Conversion from one image format to another image format, i.e. the transcoding process, as an option, also can be performed in the compressor engine. This includes compressed image/video and ROI/VOI formats.

The present invention has been described in detail, including the preferred embodiments. However, it will be appreciated that modifications and improvements may be made by those skilled in the art upon consideration of this disclosure. For example, services identified herein for a particular tier can be provided in various locations within the system. The skilled programmer can implement the services and features in innumerable ways. For example, various features can be programmed into hardware or software.

Listed below are citations to the publications to which reference is made herein. The entirety of each of these publications is hereby incorporated by reference.

### REFERENCES

Ammeraal 98: Ammeraal, L., “Algorithms and Data Structures in C++”, 1998, ISBN: 0-471-96355-0, pp. 159-228
Banister 01: Banister, B., Fischer, T, “Quadtree Classification and TCQ Image Coding”, IEEE Transactions on Circuits and Systems for Video Technology, Vol.11, No. 1, January 2001, pp. 3-8
Cohen 98: Cohen, A., Woodring, M., “Win32 Multithreaded Programming”, Chapter 3, First Edition, 1998, ISBN: 1-56592-296-4, pp. 32-64
Comer 97: Comer, D., Stevens, D., “Client-Server Programming and Applications”, 1997, ISBN: 0-13-848714-6
Christopoulos 00: Christopoulos, C., Askelof, J., Larsson, M, “Efficient Methods for Encoding Regions Of Interest in the upcoming Jpeg2000 Still Image Coding Standard”, IEEE Signal Processing Letters, Vol. 7, No. 9, September 2000, pp. 247-249
Daubechies 98: Daubechies, I., Sweldens, W., “Factoring Wavelet Transforms into Lifting Steps”, J. Fourier Anal. Appl. Vol. 4, Nr. 3, 1998, pp. 247-269
Gonzalez 92: Gonzalez, R., Woods, R., “Digital Image Processing”, Chapter 6, 1992, ISBN: 0-201-50803-6, pp. 307-411
Grangetto 02: Grangetto., M, Magli, E., Martina, M., Olmo, G., “Optimization and Implementation of the Integer Wavelet Transform for Image Coding”, IEEE Transactions on Image Processing, Vol. 11, No.6, June 2002, pp. 596-604
Marcellin 00: Marcellin, M. W., Gormish, M. J., Bolish, A. B., “An overview of Jpeg-2000”, IEEE Data Compression Conference, pp. 523-541
Nguyen 05: Nguyen, C., Redinbo, R., “Fault Tolerance Design in JPEG2000 Image Compression System”, IEEE Transactions on Dependable and Secure Computing, Vol. 2, No. 1, January-March, 2005, pp. 57-75
Oelbaum 04: Oelbaum, T., Baroncini, V., Tan, T. K, Fenimore, C., “Subjective Quality Assessment of the Emerging AVC/H.264 Video Coding Standard”, IBC 2004 Conference paper, available online at http://www.itl.nist.gov/div895/papers/IBC-Paper-AVC %20VerifTestResults.pdf
Ono 89: Ono, F., Kino, S., Yoshida, M., Kimur, T., “Bi-level image coding with MELCODE—comparison of block type code and arithmetic type code”, IEEE Global Telecommunications Conference '89, Vol. 1, November 1988, pp. 255-260
Rowe 99: Rowe, L., “Image Quality Computation”, an online course note from University of California, Berkeley, available at http://bmrc.berkeley.edu/courseware/cs294/fa1197/assignment/psnr.html
Sadoski 00: Sadoski, D., Comella-Dorda, S., “Three Tier Software Architectures”, online publication, 2000, from Carnegie Mellon Software Engineering Institute, http://www.sei.cmu.edu/str/descriptions/threetier.html
Said 96: Said, A., Pearlman, W., “A New Fast and Efficient Image Codec Based on Set Partitioning in Hierarchical Trees”, IEEE Transactions on Circuits and Systems for Video Technology, Vol. 6, June 1996, pp. 243-250
Shapiro 93: Shapiro, J., “Embedded Image Coding Using Zerotrees of Wavelet Coefficients”, IEEE Transactions on Signal Processing, Vol. 41, No. 12, December 1993, pp. 3445-3462
Soman 93: Soman, A., Vaidyanathan, P., “On Orthonormal Wavelets and Paraunitary Filter Banks”, IEEE Transaction on Signal Processing, Vol. 41, No.3, March 1993, pp. 1170-1183
Strum 89: Strum, R., Kirk, D., “Discrete Systems and Digital Signal Processing”, Chapter 6, 1989, ISBN: 0-201009518-1, pp. 281-362
Sweldens 95: Sweldens, W., “Lifting Scheme: A New Philosophy in Biorthogonal Wavelet Constructions”, Proc. of SPIE, Vol. 2569, 1995, pp. 68-79
Sweldens 98: Sweldens, W., “The Lifting Scheme: A Construction of Second Generation Wavelets”, SIAM Journal on Mathematical Analysis, Vol. 29, No.2, 1998, pp. 511-546
Taubman 00: Taubman, D., “High Performance Scalable Image Compression with EBCOT”, IEEE Transactions on Image Processing, Vol. 9, July 2000, pp. 1158-1170
Unser 03: Unser, M., Blu, T., “Mathematical Properties of the Jpeg2000 Wavelet Filters”, IEEE Transactions on Image Processing, Vol. 12, No.9, September 2003, pp. 1080-1090
Vetterli 95: Vetterli, M, Kova\check{c}ević, “Wavelets and Subband Coding”, Chapter 3-4, 1995, ISBN:0-13-097080-8, pp. 92-298
Witten 97: Witten, I., Neal, R, Cleary, J, “Arithmetic Coding for data compression”, Commun. ACM, Vol. 30, June 1987, pp. 520-540

What is claimed is:

1. An on-demand, interactive, scalable, image data compressor, data archiving, transmission and presentation system comprising a server, a compression engine, memory and user interface capable of communicating with the server, wherein the compression engine provides progressive transmission of a compressed image and provides both a tree based compression method and a context based, code block encoding compression method, either of which are selectable by the user on demand.

2. The on-demand, interactive, scalable, image data compressor, data archiving, transmission and presentation system of claim 1, wherein the compression engine can switch automatically from a lossy compression to a lossless compression to achieve a desired quality of decompressed images.

3. The on-demand, interactive, scalable, image data compressor, data archiving, transmission and presentation system of claim 1, further structured and configured to accept a user specified, on-demand amount of compression to be performed on an image.

4. The on-demand, interactive, scalable, image data compressor, data archiving, transmission and presentation system of claim 1, wherein the compression engine is further structured and configured to learn and advise an user of the best available compression ratio for an image based on stored compressed image quality measurements and the type of image content.

5. The on-demand, interactive, scalable, image data compressor, data archiving, transmission and presentation system of claim 1, further comprising a scalable image server structured and configured to provide a user with a preview lower resolution image of an original image or sequence of images before transmission of a selected image data.

6. The on-demand, interactive, scalable, image data compressor, data archiving, transmission and presentation system of claim 1, further comprising a progressive image display structured and configured to transmit an image to an end user scalable from the lowest resolution level to the highest resolution level.

7. The on-demand, interactive, scalable, image data compressor, data archiving, transmission and presentation system of claim 1, wherein the compression engine is structured and configured to compress a region of interest (ROI) of an image or volume of interest (VOI) for a sequence of related images as specified on-demand by an user.

8. The on-demand, interactive, scalable, image data compressor, data archiving, transmission and presentation system of claim 1, wherein the tree based compression method comprise a Spatial Partitioning in Hierarchical Trees (SPIHT) architecture.

9. The on-demand, interactive, scalable, image data compressor, data archiving, transmission and presentation system of claim 1, wherein the context based, code block encoding compression method comprises an Embedded Block Coding with Optimal Truncation (EBCOT) architecture.

10. The on-demand, interactive, scalable, image data compressor, data archiving, transmission and presentation system of claim 1, wherein the tree based compression method comprise a Spatial Partitioning in Hierarchical Trees (SPIHT) architecture and the context based, code block encoding compression method comprises an Embedded Block Coding with Optimal Truncation (EBCOT) architecture.

11. A method for providing image data to an end user over a low bit rate internet protocol network, the method comprising:
providing an on-demand, interactive, scalable, image data compressor, data archiving, transmission and presentation system, as set forth in claim 1;
storing image data in the system;
selecting a set of image data to be transmitted to an end user;
identifying a minimum level of image quality to be viewed by the end user for the set of image data selected;
compressing the selected set of image data by one of a tree based compression method and a context based, code block encoding compression method on demand;
transmitting the compressed image data to the end user; and
decompressing the compressed image data to provide an image having at least the minimum level of image quality for viewing by the end user.

12. The method of claim 11, wherein the set of image data includes several related images.

13. The method of claim 11, wherein the set of image data includes a cine loop.

14. The method of claim 11, wherein the step of identifying a minimum level of image quality comprises selecting a maximum compression ratio.

15. The method of claim 11, wherein the step of identifying a minimum level of image quality comprises providing an acceptable amount of image quality degradation.

16. The method of claim 11, wherein the step of identifying a minimum level of image quality comprises using a default setting based on the type of image data.

17. The method of claim 11, further comprising, for each compressed image transmitted, determining the quality of the decompressed image when compared to the original, and storing information about the image type and the compression ratio used to provide acceptable image quality.

18. The method of claim 11, further comprising switching automatically the compression engine from a lossy compression to a lossless compression to achieve a desired quality of decompressed images.

19. A method for archiving image data for transmission to an end user over a low bit rate internet protocol network, the method comprising:
providing an on-demand, interactive, scalable, image data compressor, data archiving, transmission and presentation system, as set forth in claim 1;
selecting a set of image data to be archived for subsequent viewing by an end user;
identifying a minimum level of image quality for the reconstructed image for the set of image data selected;
compressing the selected set of image data by one of a tree based compression method and a context based, code block encoding compression method on demand; and
storing the compressed image data.

20. The method of claim 19, wherein the step of identifying a minimum level of image quality comprises selecting a maximum compression ratio.

21. The method of claim 19, wherein the step of identifying a minimum level of image quality comprises providing an acceptable amount of image quality degradation.

22. The method of claim 19, wherein the step of identifying a minimum level of image quality comprises using a default setting based on the type of image data.

23. The method of claim 19, further comprising switching automatically the compression engine from a lossy compression to a lossless compression to achieve a desired quality of decompressed images.

24. A method for providing image data to an end user over a low bit rate internet protocol network, the method comprising:
providing an on-demand, interactive, scalable, image data compressor, data archiving, transmission and presentation system, as set forth in claim 1;
storing image data in the system;
selecting a set of image data to be transmitted to an end user;
identifying a compression ratio to provide a minimum level of image quality to be viewed by the end user for the set of image data selected;
compressing the selected set of image data by one of a tree based compression method and a context based, code block encoding compression method on demand;
transmitting the compressed image data to the end user; and
decompressing the compressed image data to provide an image having at least the minimum level of image quality for viewing by the end user.

25. The method of claim 24, wherein the set of image data includes several related images.

26. The method of claim 24, wherein the set of image data includes a cine loop.

27. The method of claim 24, wherein the compression ratio is identified by the system based on the type of image data being compressed.

28. The method of claim 24, further comprising switching automatically the compression engine from a lossy compression to a lossless compression to achieve a desired quality of decompressed images.

29. A method for archiving image data for transmission to an end user over a low bit rate internet protocol network, the method comprising:
providing an on-demand, interactive, scalable, image data compressor, data archiving, transmission and presentation system, as set forth in claim 1;
selecting a set of image data to be archived for subsequent viewing by an end user;
identifying a compression ratio to provide a minimum level of image quality to be viewed by the end user for the set of image data selected;
compressing the selected set of image data by one of a tree based compression method and a context based, code block encoding compression method on demand; and
storing the compressed image data.

30. The method of claim 29, wherein the compression ratio is identified by the system based on the type of image data being compressed.

31. The method of claim 29, further comprising switching automatically the compression engine from a lossy compression to a lossless compression to achieve a desired quality of decompressed images.
